(19) United States
(12) Patent Application Publication
(10) Pub. No.: US 2013/0326092 A1
(43) Pub. Date: Dec. 5, 2013

(54) PROCESSING INPUT EVENT OF EXTERNAL DEVICE

(71) Applicant: KT CORPORATION, Gyeonggi-do (KR)

(72) Inventors: You-Jin KANG, Seoul (KR); Shin-Hyuk KANG, Seoul (KR); Jae-Hun JUNG, Gyeonggi-do (KR); Jae-Uk CHA, Gyeonggi-do (KR); Sang-Ho KOH, Gyeonggi-do (KR); Jung-Suk PARK, Seoul (KR)

(73) Assignee: KT CORPORATION, Gyeonggi-do (KR)

(21) Appl. No.: 13/904,286

(22) Filed: May 29, 2013

(30) Foreign Application Priority Data
May 30, 2012 (KR) 10-2012-0057624

(51) Int. Cl. G06F 13/10

(52) U.S. Cl. CPC G06F 13/102
USPC 710/8; 719/321

(57) ABSTRACT

The disclosure is related to processing an input event of an external device in user equipment. Coupling event data may be received from the external device coupled to the user equipment. An input event type associated with the received coupling event data may be identified. Input event data may be obtained from the received coupling event data. The obtained input event data may be processed using at least one of an input application programming interface (API) and an input sub-device driver, according to the identified input event type.

### CROSS REFERENCE TO PRIOR APPLICATIONS

The present application claims priority under 35 U.S.C. §119 to Korean Patent Application No. 10-2012-0057624 (filed on May 30, 2012), which is hereby incorporated by reference in its entirety.

The subject matter of this application is related to U.S. patent application Ser. No. 13/540,112 filed Jul. 2, 2012, as Attorney Docket No.: (801.0050), U.S. patent application Ser. No. 13/539,929 filed Jul. 2, 2012, as Attorney Docket No.: (801.0051), U.S. patent application Ser. No. 13/460,091 filed Apr. 30, 2012, as Attorney Docket No.: (801.0061), U.S. patent application Ser. No. 13/598,741 filed Aug. 30, 2012, as Attorney Docket No.: (801.0081), U.S. patent application Ser. No. 13/726,361 filed Dec. 24, 2012, as Attorney Docket No.: (801.0083), U.S. patent application Ser. No. 13/726,811 filed Dec. 26, 2012, as Attorney Docket No.: (801.0085), U.S. patent application Ser. No. 13/726,830 filed Dec. 26, 2012, as Attorney Docket No.: (801.0086), U.S. patent application Ser. No. 13/726,384 filed Dec. 24, 2012, as Attorney Docket No.: (801.0087), U.S. patent application Ser. No. 13/726,404 filed Dec. 24, 2012, as Attorney Docket No.: (801.0088), and U.S. patent application Ser. No. 13/726,422 filed Dec. 24, 2012, as Attorney Docket No.: (801.0089), the teachings of which are incorporated herein their entirety by reference.

### FIELD OF THE INVENTION

The present invention relates to communications and, in particular, to processing an input event which is generated in an external device coupled to user equipment.

### BACKGROUND OF THE INVENTION

User equipment has advanced so as to perform multiple functions such as communicating voice and data with others; exchanging text messages or multimedia messages; sending e-mails; capturing a still or moving image; playing back a music or a video file; playing a game; and receiving a broadcast signal. Lately, such multi-functional user equipment has received greater attention for new applications. Instead of using multiple independent devices, a user prefers to use single multifunction-enabled user equipment. Portability and/or mobility should be considered in design of user equipment, but such user equipment has limitations in size. Accordingly, there also are limitations in display screen size, screen resolution, speaker performance, and input units.

In order to overcome such limitations, an external device having a large display size, better speaker performance, various and convenient input units, and being connectable to a mobile terminal has been introduced. Such an external device connected to the mobile terminal can provide data, music files, and other content stored in the mobile terminal in better performance, and also provide various and convenient input units for a user.

### SUMMARY OF THE INVENTION

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present invention, user equipment may process an input event generated in a coupled external device.

In accordance with an embodiment of the present invention, a method may be provided for processing an input event of an external device in user equipment. The method may include receiving coupling event data from the external device coupled to the user equipment, identifying an input event type associated with the received coupling event data, obtaining input event data from the received coupling event data, and processing the obtained input event data using at least one of an input application programming interface (API) and an input sub-device driver, according to the identified input event type.

The method may further include reconfiguring a device control path in association with the external device.

The reconfiguring may include receiving external sub-device information on at least one external sub-device included in the external device, from the external device, selecting at least one external sub-device to be controlled by the user equipment, among the at least one external sub-device, obtaining sub-device information on at least one sub-device of user equipment corresponding to the selected at least one external sub-device, transmitting the obtained sub-device information to the external device, and reconfiguring the device control path such that a corresponding external sub-device may be controlled.

At least one of a structure and a size of the coupling event data may be determined based on at least one of a data transmission amount and a data transmission period.

The data transmission period may be determined based on a data interrupt processing speed of the user equipment.

The coupling event data may include a header including a device type and an event state, and an input event data field; and the event state may include a device connection state; and a property of input event data included in the input event data field.

The coupling event data may be received from the external device in burst mode through a control bus (CBUS) of a mobile high-definition link (MHL) port.

The processing may include transferring, by an MHL transceiving driver, the obtained input event data and the identified input event type to a coupling agent, and forwarding, by the coupling agent, the transferred input event data to the corresponding input API according to the identified input event type.

The processing may include transferring, by an MHL transceiving driver, the obtained input event data to the corresponding input sub-device driver according to the identified input event type.

The processing may include transferring, by an MHL transceiving driver, the obtained input event data and the identified input event type to a coupling agent when the identified input event type is an API related input event, forwarding, by the coupling agent, the transferred input event data to the corresponding input API according to the identified input event type, and transferring, by the MHL transceiving driver, the obtained input event data to the corresponding input sub-device driver when the identified input event type is a driver related event.

In accordance with another embodiment of the present invention, a method may be provided for processing an input event in an external device coupled to user equipment. The method may include sensing input event data generated from at least one input unit of the external device, creating coupling event data including the generated input event data and input event type information, and transmitting the created coupling event data to the user equipment.

The method may further include performing an operation setting synchronization in association with the user equipment.

The performing may include transmitting external sub-device information on at least one external sub-device included in the external device, to the user equipment, receiving operation setting information on at least one sub-device of user equipment corresponding to the at least one external sub-device, and changing the operation setting of the at least one external sub-device, based on the received operation setting information.

At least one of a structure and a size of the coupling event data may be determined based on at least one of a data transmission amount and a data transmission period.

The data transmission period may be determined based on a data interrupt processing speed of the user equipment.

The created coupling event data may include a header including a device type and an event state, and an input event data field.

The event state may include a device connection state, and a property of input event data included in the input vent data field.

The header may have a size of about 4 bytes, and the input event data field may have a size of about 12 bytes.

The generated input event data may include at least one of key input event data, pointing input event data, and touch input event data.

The created coupling event data may be transmitted to the user equipment in burst mode through a control bus (CBUS) of a mobile high-definition link (MHL) port.

The creating may be performed by a coupling manager.

The transmitting may include storing, by an MHL transceiving driver, the created coupling event data received from the coupling manager, and transmitting the stored coupling event data by the MHL transceiving driver.

In accordance with still another embodiment of the present invention, user equipment may be provided for processing an input event generated in a coupled external device. The user equipment may include a transceiving driver, a coupling agent, and an input sub-device driver. The transceiving driver may be configured to receive coupling event data from the coupled external device and to transfer input event data included in the received coupling event data according to a corresponding input event type. The coupling agent may be configured to forward the input event data transferred from the transceiving driver, to a corresponding input application programming interface (API). The input sub-device driver may be configured to process the input event data transferred from the transceiving driver.

The transceiving driver may be configured to receive the coupling event data from the external device in burst mode through a control bus (CBUS) of a mobile high-definition link (MHL) port.

In accordance with still another embodiment of the present invention, an external device may be provided for processing an input event. The external device may include a coupling managing unit and a transceiving driver. The coupling managing unit may be configured to create coupling event data including input event data and input event type information when the input event is generated in the external device coupled to user equipment. The transceiving driver may be configured to transmit the created coupling event data to the coupled user equipment.

The transceiving driver may be configured to transmit the created coupling event data to the user equipment in burst mode through a control bus (CBUS) of a mobile high-definition link (MHL) port.

In accordance with still another embodiment of the present invention, a non-transitory computer-readable recoding medium storing a computer-executable program that, when executed, causes a computer to perform a method of processing an input event of an external device. The method may include receiving coupling event data from the external device coupled to the user equipment, identifying an input event type associated with the received coupling event data, obtaining input event data from the received coupling event data, and processing the obtained input event data using at least one of an input application programming interface (API) and an input sub-device driver, according to the identified input event type.

In accordance with still another embodiment of the present invention, a non-transitory computer-readable recoding medium storing a computer-executable program that, when executed, causes a computer to perform a method of processing an input event generated in external device. The method may include sensing input event data generated from at least one input unit of the external device, creating coupling event data including the generated input event data and input event type information, and transmitting the created coupling event data to the user equipment.

### BRIEF DESCRIPTION OF THE DRAWINGS

The above and/or other aspects of the present invention will become apparent and more readily appreciated from the following description of embodiments, taken in conjunction with the accompanying drawings, of which:

FIGS. 1A and 1B illustrate user equipment and an external device in accordance with at least one embodiment of the present invention;

FIG. 2 illustrates user equipment coupled to an external device in accordance with at least one embodiment of the present invention;

FIG. 3 illustrates various coupling manners of user equipment and various types of external devices connected to the user equipment;

FIG. 4 is a block diagram illustrating user equipment in accordance with at least one embodiment of the present invention;

FIG. 5 is a block diagram illustrating an external device in accordance with at least one embodiment of the present invention;

FIG. 6 illustrates a (external) sub-device identification table in accordance with at least one embodiment of the present invention;

FIGS. 7A and 7B illustrate a port unit of user equipment in accordance with at least one embodiment of the present invention;

FIG. 8 illustrates establishing a connection between user equipment and an external device in accordance with at least one embodiment of the present invention;

FIG. 9 illustrates processing an input event generated in an external device in accordance with at least one embodiment of the present invention;

FIGS. 10A to 10C illustrate a structure of a coupling event data frame in accordance with at least one embodiment of the present invention;

FIG. 11 illustrates creating a coupling event data in an external device and transmitting the created coupling event data to user equipment in accordance with at least one embodiment of the present invention; and

FIG. 12A to FIG. 12C illustrate processing a coupling event data in user equipment in accordance with at least one embodiment of the present invention.

### DETAILED DESCRIPTION OF THE INVENTION

Reference will now be made in detail to embodiments of the present invention, examples of which are illustrated in the accompanying drawings, wherein like reference numerals refer to like elements throughout. The embodiments are described below, in order to explain the present invention by referring to the figures.

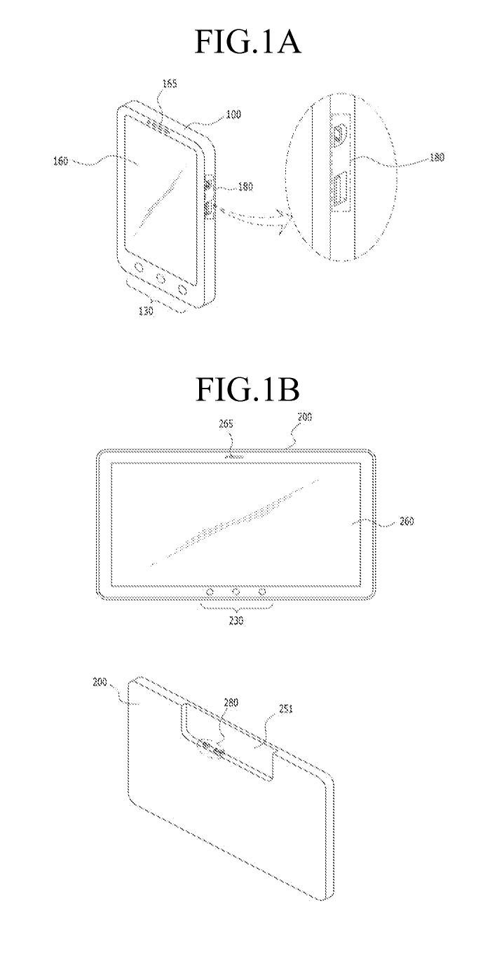

In accordance with at least one embodiment of the present invention, user equipment may process an input event generated in a coupled external device. More specifically, when an input event is generated in an external device coupled to user equipment, the external device may create coupling event data for mobile high-definition link (MHL) transmission and transmit the created coupling event data to the user equipment. When receiving the coupling event data, the user equipment may process input event included in the received coupling event data, according to input event types. Furthermore, the user equipment may process the included input event data through: (1) a coupling agent, (2) an input sub-device driver, or (3) one of the coupling agent and an input sub-device driver according to input event types. Before describing such operation, user equipment and a connectable external device will be described with reference to FIG. 1A to FIG. 5.

FIG. 1A illustrates user equipment 100 and FIG. 1B illustrates external device 200 in accordance with at least one embodiment of the present invention.

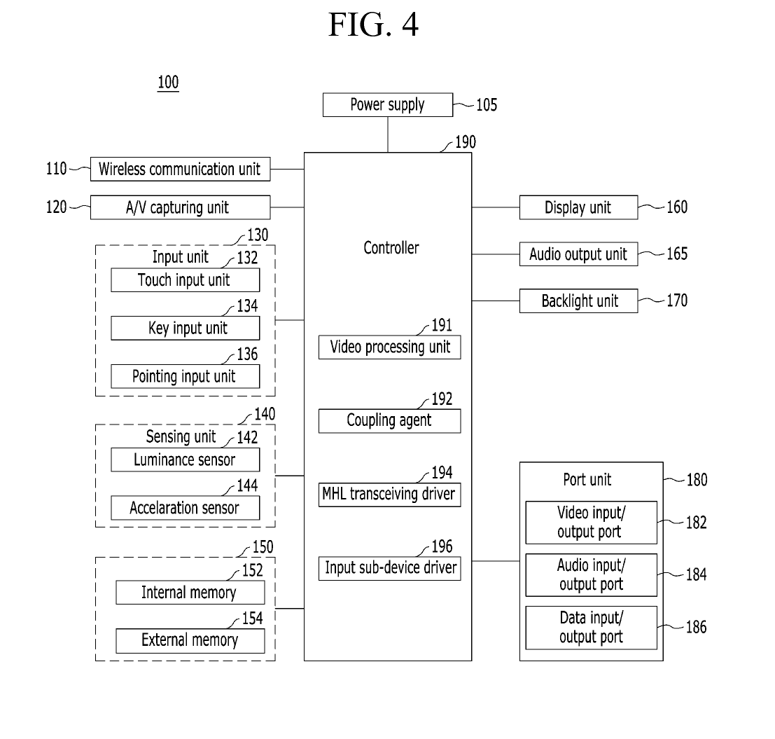

Referring to FIG. 1A, user equipment 100 may include display unit 160 and at least one port unit 180. Display unit 160 may display data according to display setting of user equipment 100. Display unit 160 may typically have about 4.5 inch display area which is smaller than that of external device 200 (FIG. 1B), but the present invention is not limited thereto. For example, a display area of external device 200 may be smaller than that of user equipment 100. At least one port unit 180 may be coupled to external device 200 and exchange data. User equipment 100 may be capable of processing data, displaying the processed data on display unit 160, and transferring the processed data to an external device through port unit 180. Particularly, user equipment 100 may process image data corresponding to a display setting of display unit 160 and display the processed image data on display unit 160. As described above, user equipment 100 may include at least one port unit 180. Such port unit 180 may include a mobile high-definition link (MHL) port, but the present invention is not limited thereto. User equipment 100 may have a certain design or standardized interface connectable to external device 200. For example, user equipment 100 may be attachable to and/or detachable with a cable or wireless radio from external device 200. User equipment 100 may dock to external device 200. User equipment 100 may be any electronic device that can perform the above and further operations described herein. For example, user equipment 100 may include, but is not limited to, a mobile terminal, a mobile device, a mobile phone, a portable terminal, a portable device, a handheld device, a cellular phone, a smart phone, an access terminal, a remote station, a remote terminal, a user agent, a personal digital assistant (PDA), a satellite phone, a session initiation protocol (SIP) phone, a wireless local loop (WLL) station, a portable multimedia player (PMP), and a navigation device. The present invention, however, is not limited thereto, and other types of user equipment, such as mini-laptop PCs and other computing devices may incorporate embodiments of the present invention. User equipment 100 will be described in more detail with reference to FIG. 4.

As shown in FIG. 1B, external device 200 may include display unit 260 and at least one port unit 280. Display unit 260 may display data. Display unit 260 may have a display area larger than that of user equipment 100. For example, display unit 260 may have about 10.1 inch of display area. The present invention, however, is not limited thereto. External device 200 may have a display area smaller than that of user equipment 100. At least one port unit 280 may be coupled to corresponding port unit 180 of user equipment 100 for exchanging data with user equipment 100. Accordingly, at least one port unit 280 may include an MHL port corresponding to port unit 180 of user equipment 100. External device 200 may be capable of receiving data from user equipment 100 through at least one port unit 280 and displaying the received data on display unit 260. External device 200 may have a certain design connectable to user equipment 100 through at least one port unit 280. For example, external device 200 may be attachable to and/or detachable from user equipment 100 as described above with respect to FIG. 1A. External device 200 may have a structure for receiving and holding user equipment 100. Such a structure may be referred to as coupling bay 251. External device 200 may be any electronic device that can perform the above operation. For example, external device 200 may include a notebook computer, a laptop computer, a tablet PC, a pad having a touch screen, and a pad having a display unit and a keyboard, but the present invention is not limited thereto. In accordance with at least one embodiment of the present invention, external device 200 may be activated when user equipment 100 is connected to external device 200 and controlled by user equipment 100. Accordingly, external device 200 may have at least constituent elements for necessary operation performed under the control of user equipment 100.

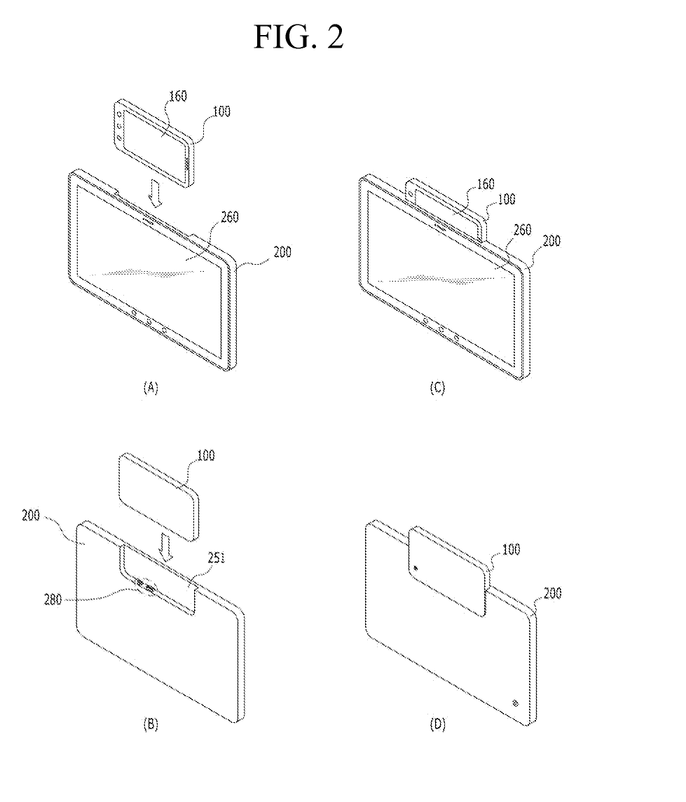

As described above, user equipment 100 may be coupled to external device 200. For example, at least one port unit 180 of user equipment 100 may be coupled to at least one port unit 280 of external device 200. In accordance with at least one embodiment of the present invention, user equipment 100 may be coupled to external device 200 in a docking manner. Such coupling manner will be described with reference to FIG. 2.

FIG. 2 illustrates user equipment coupled to an external device in accordance with at least one embodiment of the present invention.

Referring to FIG. 2, user equipment 100 may be inserted in coupling bay 251 of external device 200 in a top-to-bottom direction as shown in a diagram (A). As shown in a diagram (B), display unit 160 of user equipment 100 and display unit 260 of external device 200 may face the same direction while user equipment 100 is inserted into coupling bay 251 of external device 200. As shown in diagrams (C) and (D), user equipment 100 may be completely inserted into coupling bay 251 of external device 200 until at least one port unit 180 of user equipment 100 is interlocked to at least one port unit 280 of external device 200. Although FIG. 2 shows that user equipment 100 is coupled with external device 200 in a docking manner, the present invention is not limited thereto. User equipment 100 may be coupled to external device 200 in other manners.

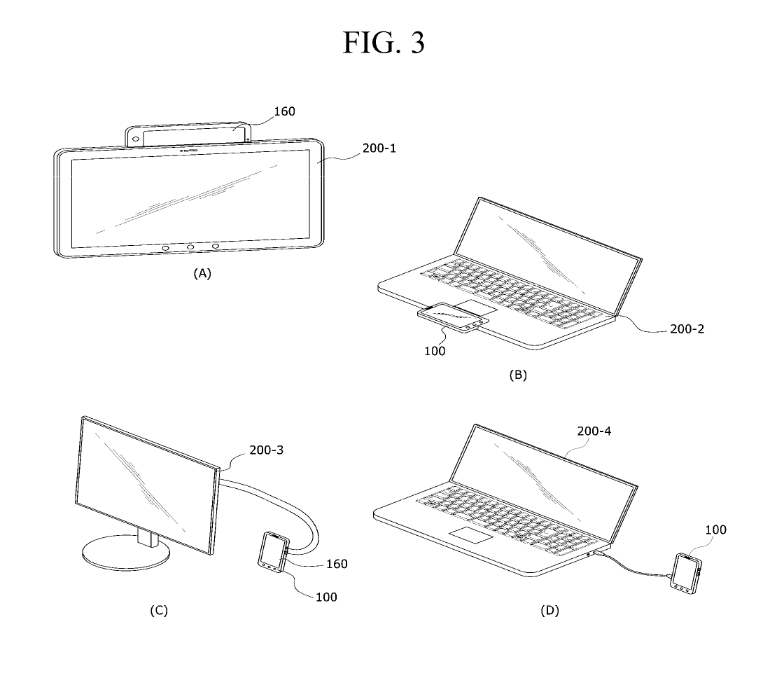

FIG. 3 illustrates various coupling manners of user equipment and various types of external devices connected to the user equipment.

Referring to FIG. 3, user equipment 100 may be coupled to a pad type device 200-1 in a docking manner as show in a diagram (A). Furthermore, user equipment 100 may be coupled to a laptop computer 200-2 in a docking manner as show in a diagram (B). User equipment 100 may be coupled to a monitor 200-3 through a physical cable as shown in a diagram (C). User equipment 100 may be coupled to a laptop computer 200-2 through a physical cable (e.g., MHL cable) as show in a diagram (D). In at least one embodiment, user equipment 100 may be coupled to external device 200 through a hub (not shown).

As shown, user equipment 100 may be coupled to external device 200 in various manners. After user equipment 100 is coupled to external device 200, user equipment 100 may exchange data with external device 200 through port units 180 and 280. In accordance with at least one embodiment of the present invention, user equipment 100 may control external device 200 by exchanging data through a communication link formed between port unit 180 of user equipment 100 and port unit 280 of external device 200.

User equipment 100 may be connected to various types of external devices such as pad type external device 200-1, laptop computers 200-2 and 200-4, and monitor 200-3. Such external devices may also include a game device, a navigation system, and a television set (TV). Each external device may have different constituent elements with unique properties.

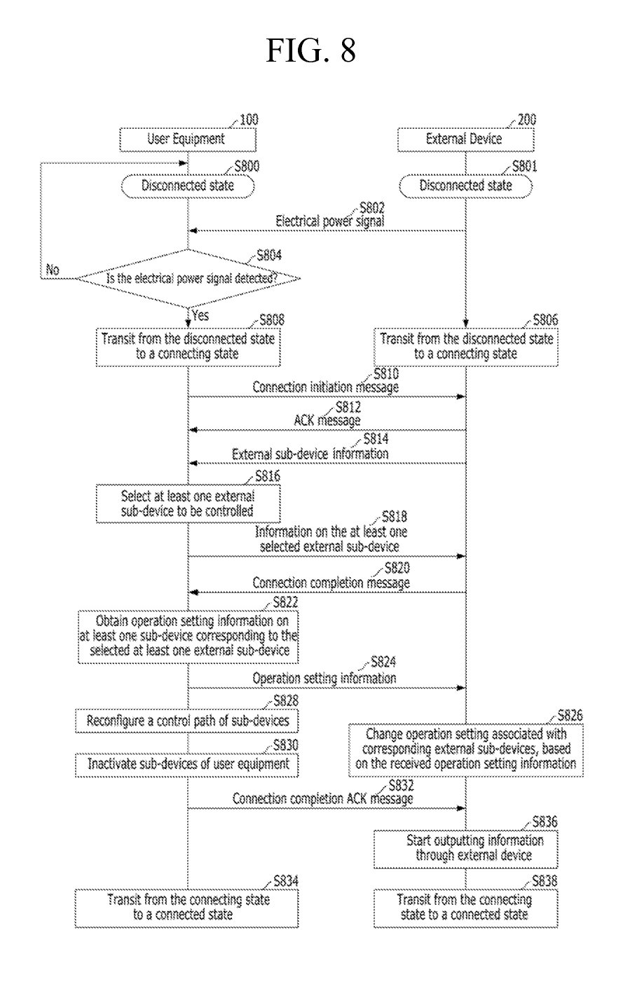

Hereinafter, user equipment 100 will be described in more detail with reference to FIG. 4. As described above, user equipment 100 may be coupled to various types of external devices including external device 200 and control the connected external device in accordance with at least one embodiment of the present invention. Particularly, user equipment 100 may process an input event (e.g., a keyboard input, a mouse input, etc.) generated in a coupled external device 200. Such input event processing procedures in external device 200 and user equipment 100 will be described in more detail with reference to FIG. 8 to FIG. 12C.

FIG. 4 is a block diagram illustrating user equipment in accordance with at least one embodiment of the present invention.

Referring to FIG. 4, user equipment 100 may include at least one constituent elements such as wireless communication unit 110, audio/video (A/V) capturing unit 120, input unit 130, sensing unit 140, memory 150, display unit 160, audio output unit 165, backlight unit 170, port unit 180, controller 190, and power supply 105. Hereinafter, a constituent element included in user equipment 100 may be referred to as a “sub-device.” Input unit 130 may include touch input unit 132, key input unit 134, and pointing input unit 136. Sensing unit 140 may include luminance sensor 142 and acceleration sensor 144. Controller 190 may include video processing unit 191, coupling agent 192, MHL transceiving driver 194, and input sub-device driver 196. Port unit 180 may include video input/output port 182, audio input/output port 184, and data input/output port 186. Power supply unit 105 may supply an electric power to operate user equipment 100 and include a battery for electric charging. User equipment 100 may be described as including the above constituent elements, but the present invention is not limited thereto.

Wireless communication unit 110 may include at least one module for communicating with other party through a wireless communication system. For example, wireless communication unit 110 may include any or all of a broadcasting signal receiving module, a mobile communication module, a wireless internet module, a short-distance communication module, and a location information module (e.g., GPS receiving module). In accordance with at least one embodiment of the present invention, wireless communication unit 110 may be not necessarily be an essential unit for user equipment 100 because user equipment 100 may be not necessarily be required to communicate with another party. For example, in case of user equipment 100 coupled to external device 200 in a docking manner or through a physical cable as shown FIG. 3, user equipment 100 may not include wireless communication unit 110. In this case, user equipment 100 may be a terminal that includes a wired communication module or does not support communication functions. Accordingly, wireless communication unit 110 may be omitted in accordance with another embodiment of the present invention.

A/V capturing unit 120 may capture an audio signal and/or a video signal. For example, A/V capturing unit 120 may include a camera and/or a microphone. The camera may process image frames of a still image or a moving image, which are captured by an image sensor in a video call mode or a photographing mode. The microphone may receive an audio signal provided externally in an on-call mode, a recording mode, or a voice recognition mode.

Input unit 130 may be a user interface for receiving input (e.g., user commands) from a user. Input unit 130 may be realized in various types. For example, input unit 130 may include touch input unit 132, key input unit 134, and pointing input unit 136. Herein, touch input 132 may include a touch screen. Key input unit 134 may include a keyboard and/or a keypad. Pointing input unit may include a mouse device and/or a touchpad. Input unit 130 may include a dome switch, a jog wheel, and a jog switch, but is not limited thereto. Particularly, with respect to the touch screen, user equipment 100 may be a full touch type smart phone. In this case, input unit 130 may include several hardware key buttons and a touch screen. The hardware key buttons may include a hold key and a volume control button. The touch screen may be disposed on an upper surface of display unit 160, but the present invention is not limited thereto.

In accordance with at least one embodiment of the present invention, input unit 130 may be configured to receive selection inputs from a user for selecting at least one of external sub-devices included in external device 200. For example, a user may make such selection inputs based on a graphic user interface (GUI) provided to the user through display unit 160.

Sensing unit 140 may detect a current status of user equipment 100. Sensing unit 140 may include luminance sensor 142 and acceleration sensor 144. Sensing unit 140 may further include a variety of sensors such as a gyro sensor, a proximity sensor, a contact sensor, and so forth. For example, sensing unit 140 may sense an opening or closing of a cover of user equipment 100, a location and a bearing of user equipment 100, acceleration and deceleration of user equipment 100, or physical contact with or proximity to a user. Based on the detected status of user equipment 100, sensing unit 140 may generate a sensing signal to control the operation of user equipment 100. For example, in the case of a mobile phone having a sliding type cover, sensing unit 140 may sense whether a cover is opened or closed. Sensing unit 140 may sense whether power supply 105 supplies power. Furthermore, sensing unit 140 may sense connection to external device 200 when user equipment 100 is coupled to external device 200 in accordance with at least one embodiment of the present invention. For example, when user equipment 100 is physically coupled to external device 200, external device 200 may provide user equipment 100 with a signal. Upon the receipt of the signal, external device 200 may establish a connection between user equipment 100 and external device 200. Particularly, when port unit 180 includes an MHL port, the signal may be transferred through an MHL 5V power pin of the MHL port. In this case, the signal may be electric power supplied from external device 200 to user equipment 100. User equipment 100 may be configured to receive power through the MHL 5V power pin while external device 200 is powered on. Accordingly, when user equipment 100 is coupled to external device 200 through port unit 180, power may be transmitted as the signal to user equipment 100 through the MHL 5V power pin of MHL port. When user equipment 100 is disconnected from external device 200, power may be not supplied to user equipment 100.

Video processing unit 191 may process an image signal and/or image data under the control of controller 190. Particularly, video processing unit 191 may process image data according to a display setting determined based on display unit information of display unit 160. The display setting may include a screen size, a screen resolution, a display direction, and a dot per inch (DPI) value. The display setting may be determined by controller 190 based on display unit information of display unit 160. The display unit information may include a manufacturer, a model number, a device identifier (ID), a DPI value, a screen size, the number of pixels, supporting screen resolutions, supporting aspect ratios, refresh rates, and a response time. Video processing unit 191 may transmit the processed image data to display unit 160 of user equipment 100 in response to controller 190. Furthermore, video processing unit 191 may process image data to be transmitted to external device 200 when user equipment 100 is connected to external device 200. For example, video processing unit 191 may reconfigure image data based on a display setting of external device 200 and generate a signal based on the reconfigured image data in response to controller 190. The present invention, however, is not limited thereto. Such an operation may be performed by controller 190. The image data may be data for displaying a graphic user interface produced by any software programs installed in user equipment 100, such as an operating system and applications installed in user equipment 100.

Memory 150 may be used as a data storage device of user equipment 100. Memory 150 may include internal memory 152 and external memory 154. For example, internal memory 152 and external memory 154 may store information necessary for operating user equipment 100 and performing certain operations requested by a user. Such information may include any software programs and related data. For example, internal memory 152 and external memory 154 may store an operation system data, applications, and related data, received from an external device through a physical cable and downloaded from a related server from through a communication link. In accordance with at least one embodiment of the present invention, internal memory 152 and/or external memory 154 may store information on display setting determined for display unit 160 or display unit 260 of external device 200. Furthermore, internal memory 152 and external memory 154 may store device unit information for candidate external devices connectable to user equipment 100. In addition, internal memory 152 and/or external memory 154 may store a DPI table (not shown). Internal memory 152 may be a flash memory, hard disk, multimedia card micro memory, SD or XD memory, Random Access Memory (RAM), Static Random Access Memory (SRAM), Read-Only Memory (ROM), Programmable Read-Only Memory (PROM), Electrically Erasable Programmable Read-Only Memory (EEPROM), magnetic memory, magnetic disk, or optical disk, but is not limited thereto. External memory 154 may be a SD card or a USB memory, but the present invention is not limited thereto. For example, external device 200 may function as external memory 154 when external device 200 is coupled to user equipment 100 in accordance with an embodiment of the present invention.

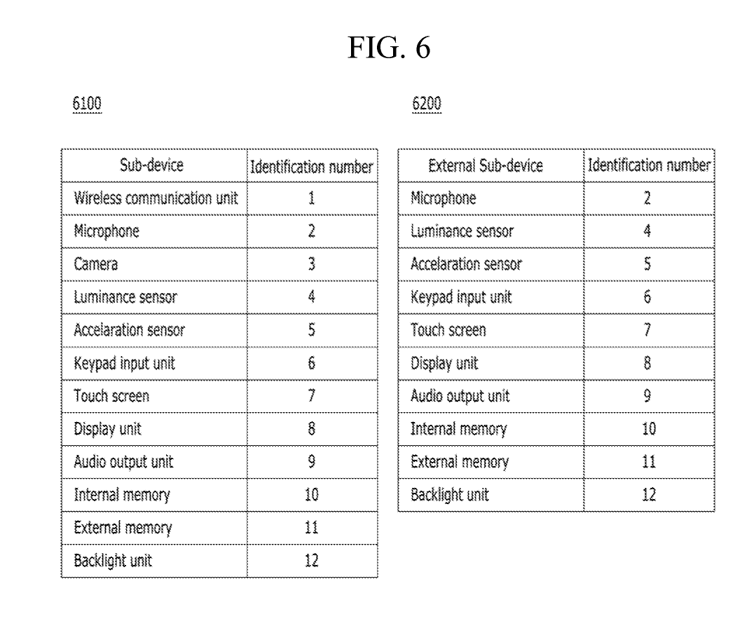

In accordance with embodiment of the present invention, at least one of internal memory 152 and external memory 154 may store external sub-device information (see “6200” of FIG. 6) received from external device 200. The external sub-device information may include device type information (e.g., external sub-device type information) and identification numbers associated with each external sub-device.

Further, internal memory 152 and external memory 154 may store a sub-device identification table (see “6100” of FIG. 6) and application information. The sub-device identification table may include device type information associated with sub-devices included in user equipment 100, and identification numbers associated with each sub-device. The device table may be used to obtain the external device information. The application information may include information on whether an application is required for optimally controlling and driving constituent elements (i.e., external sub-devices) of the external device, an application type, and an address of a server for obtaining the required application. The application information may be used to determine an application required for controlling external sub-devices of the connected external device such as external device 200.

Display unit 160 may be an output device for visually displaying information. For example, display unit 160 may display image data produced or processed by video processing unit 191 and/or controller 190. Display unit 160 may receive the image data from at least one of video processing unit 191 and controller 190 and display the received image data. The image data may be produced as a result of certain operations performed by any software programs installed in user equipment 100. For example, the image data may be data processed for displaying a graphic user interface produced by an operation system and applications, performed in user equipment 100. The applications may be referred to as “App”. Also, the image data may further include still images and moving images, produced or processed by video processing unit 191 and controller 190. For example, display unit 160 may be a liquid crystal display (LCD) panel or an active-matrix organic light-emitting diode (AMOLED) panel, but the present invention is not limited thereto.

In accordance with at least one embodiment of the present invention, display unit 160 may be interrupted to display the image data when user equipment 100 is connected to external device 200. For example, display unit 160 may be turned off or transit to a sleep mode in response to controller 190 when user equipment 100 is connected to external device 200. Display unit 160 may be turned on again or transit back to an operation mode in response to controller 190 when user equipment 100 is disconnected from external device 200.

In accordance with at least one embodiment of the present invention, display unit 160 may display a graphic user interface for enabling the user to select at least one of external sub-devices in included external device 200. Such graphic user interface may be created by controller 190 and video processing unit 191.

Audio output unit 165 may provide an output audio signal that may be produced or processed by controller 190 as a result of operations performed by an operating system and/or applications installed in user equipment 100. Audio output unit 165 may include a speaker, a receiver, and a buzzer.

Backlight unit 170 may be a light emitting device disposed under display unit 160. Backlight unit 170 may improve readability of display unit 160. Backlight unit 170 may be a cold cathode fluorescent lamp (CCFL), an external electrode fluorescent lamp (EEFL), a light emitting diode (LED), and a flat fluorescent lamp (FFL).

Port unit 180 may include at least one port for exchanging signals and/or data with external device 200. In accordance with at least one embodiment of the present invention, port unit 180 may transfer image data and audio data from user equipment 100 to external device 200. Port unit 180 may exchange control data with external device 200. Port unit 180 may be coupled to corresponding port unit 280 of external device 200 in various coupling manners. For example, port unit 180 may be coupled to corresponding port unit 280 of external device 200 through a physical cable. Furthermore, port unit 180 may be directly interlocked with corresponding port unit 280 of external device 200. The present invention, however, is not limited thereto. Port unit 180 may be coupled to corresponding port unit 280 of external device 200 through a radio link formed between user equipment 100 and external device 200. In this case, port unit 180 and port unit 280 may include a wireless signal transmitter and receiver (not shown) for communicating with each other using a predetermined communication protocol. Such communication protocol may be Bluetooth® or WiFi, for example, but the present invention is not limited thereto.

As shown in FIG. 4, port unit 180 may include video input/output port 182, audio input/output port 184, and data input/output port 186, but the present invention is not limited thereto. Such port unit 180 may be embodied in various types. For example, port unit 180 may not include audio input/output interface 184. Further, port unit 180 may include a power port (not shown). In this case, the power port may transfer power from external device 200 to user equipment 100 when external device 200 is coupled to user equipment 100.

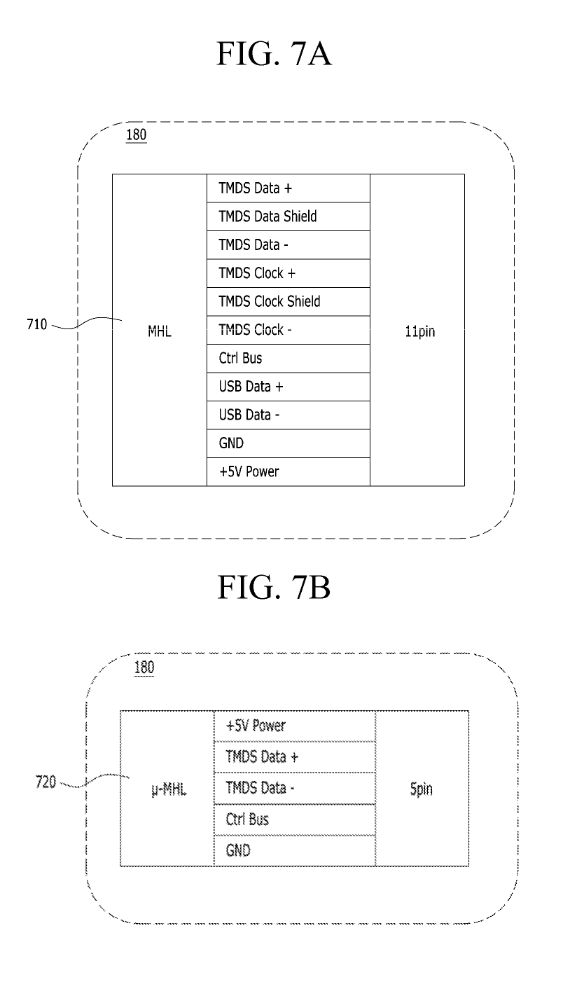

Port unit 180 will be described in detail with reference to FIG. 7A and FIG. 7B in later. Referring to FIG. 7A and FIG. 7B, port unit 180 may be an interface for inputting and outputting audio and video signals and/or control signals. Port unit 180 may include mobile high-definition link (MHL) port 710 or micro (t)-MHL port 720. In this case, port unit 180 may include MHL (or g-MHL) transmitting/receiving drivers supporting an MHL standard. The present invention, however, is not limited thereto. In another embodiment of the present invention, port unit 180 may include other types of connectors and ports such as high definition multimedia interface (HDMI) port and/or universal serial bus (USB) port.

Such MHL port 710 and/or g-MHL port 720 may enable user equipment 100 to be connected to various types of typical electronic devices, such as a television set, a monitor, audio devices, or a laptop, which have an MHL port and/or a g-MHL port. Accordingly, video and/or audio data processed in user equipment 100 may be output through the above typical electronic devices (e.g., the television set, the monitor, the audio devices, or the laptop) although such general electronic devices do not have configuration like external device 200.

In accordance with at least one embodiment of the present invention, user equipment 100 may be coupled to external device 200 through port unit 180. After user equipment 100 coupled to external device 200, user equipment 100 may control external device 200 by exchanging data with external device 200 through port unit 180. For example, user equipment 100 may receive inputs from a user through external device 200 and transmit control data to external device 200 through port unit 180. Particularly, user equipment 100 may transmit image data through port unit 180 to external device 200 and control external device 200 to display the image data such a graphic user interface instead of display unit 160 of user equipment 100. Furthermore, user equipment 100 may transmit, through port unit 180, operation results of an application tailored for optimally controlling and driving constituent elements of connected external device 200.

Controller 190 may control overall operation of the constituent elements of user equipment 100. Particularly, controller 190 may perform operations necessary for driving the constituent elements of user equipment 100 in response to inputs received from a related user. Controller 190 may control overall operation of constituent elements of external device 200 when user equipment 100 is connected to external device 200. For example, controller 190 may receive inputs from a user through external device 200, perform an operation in response to the received inputs, and provide the user with the result thereof through external device 200. Particularly, controller 190 may display image data, as a result of operation related to the user inputs, on a display unit of external device 200 when user equipment 100 is connected to external device 200. In at least one embodiment of the present invention, when user equipment 100 is connected to external device 200, controller 190 may i) inactivate display unit 160 of user equipment 100, ii) synchronize an operation state of display unit 160 with display unit 260 of external device 200, iii) transmit processed video data to external device 200, and/or iv) control display unit 260 of external device 200 to display the processed video data.

As described above, controller 190 may control constituent elements (i.e., external sub-devices) of external device 200, associated with the same type of constituent elements of user equipment 100 when user equipment 100 is connected to external device 200. The same type of constituent elements (i.e., sub-devices) of user equipment 100 and external device 200 may be constituent element having the same identification number. For example, when user equipment 100 is connected to external device 200, controller 190 may control input unit 230, sensing unit 240, display unit 260, and audio output unit 265 of external device 200 instead of input unit 130, sensing unit 140, display unit 160, and audio output unit 165 of user equipment 100.

In order to control the constituent elements of external device 200 instead of corresponding constituent elements of user equipment 100, user equipment 100 may change a control path including a command control path and/or an event control path. The control path may be a path for transferring data between controller 190 and related constituent elements. The data may denote data necessary for controlling constituent elements and outputting operation results through constituent elements. Particularly, the control path may include a command control path and an event control path. The command control path may be a path for transferring commands from controller 190 to a related constituent element when controller 190 generates the commands. The event control path may be a path for transferring events from a constituent element to controller 190 when the constituent element generates the events. That is, when user equipment 100 is connected to external device 200, controller 190 may transfer commands generated in user equipment 100 to constituent elements of external device 200 by changing a command control path to transfer the generated commands to the constituent elements of external device 200. When user equipment 100 is disconnected from external device 200, controller 190 may transfer commands back to constituent elements of user equipment 100 by restoring the initial command control path to transfer the generated data to the constituent elements of user equipment 100. Furthermore, when user equipment 100 is connected to external device 200, controller 190 may process events received from constituent elements of external device 200 by changing an event control path to receive the generated event from the constituent elements of external device 200. When user equipment 100 is disconnected from external device 200, controller 190 may process events received from constituent elements of user equipment 100 by restoring an initial event control path to receive the generated event from constituent elements of user equipment 100.

For example, a command may be for turning on/off constituent elements such as display units 160 and 260. In response such command, display units 160 and 260 may be turned on/off. A command may be for reading state values of constituent elements such as sensor units 140 and 240. In response such command, sensing units 140 and 240 may return a sensing result value to controllers 190 and 290. A command may be for setting properties of constituent elements such as backlight units 170 and 270. In response such command, backlight units 170 and 270 may perform related operation with the set properties. Such commands may be referred to as control data.

In at least one embodiment of the present invention, controller 190 may include coupling agent 192, MHL transceiving driver 194, and input sub-device driver 196. Coupling agent 192 may control operations related to connection to external device 200. Such coupling agent 192 may be referred to as a docking agent, but the present invention is not limited thereto. Coupling agent 192 may be implemented in software. For example, coupling agent 192 may be realized on an application layer in an operating system (OS) structure of user equipment 100. For example, the OS structure may be an OS structure of an android operating system, but present invention is not limited thereto. Furthermore, coupling agent 192 may receive data generated in controller 190 and transfer the received data to external device 200 through port unit 180 when user equipment 100 is connected to external device 200.

Coupling agent 192 may control a control path according to whether user equipment 100 is connected to external device 200 or not. Particularly, coupling agent 192 may change a control path to transfer data generated in user equipment 100, such as control data or commands, to external device 200 when user equipment is connected to external device 200. In this case, when control data is generated in controller 190, coupling agent 192 may transfer the generated control data to related external sub-devices of external device 200. Coupling agent 192 may change a control path to receive data generated in external device 200, such as input events, to user equipment 100 when user equipment 100 is connected to external device 200. In this case, coupling agent 192 may receive the generated data from external device 200 and transfer the received data to controller 190.

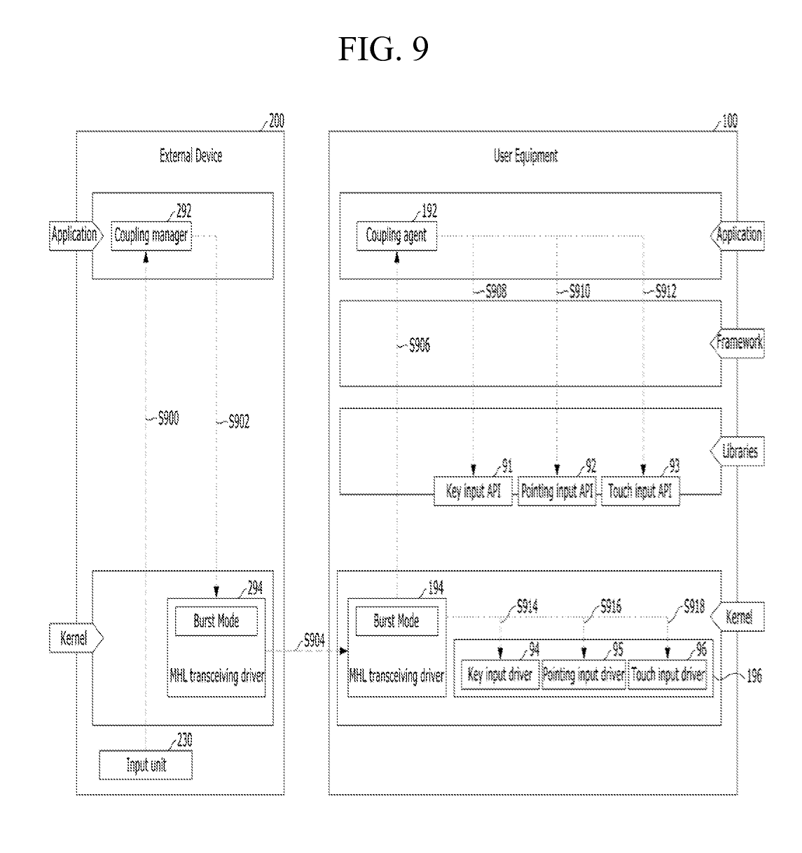

In at least one embodiment of the present invention, when an input event is generated in external device 200 connected to user equipment 100, MHL transceiving driver 194 of user equipment 100 may receive coupling event data associated with the input event, from MHL transceiving driver 294 of external device 200 through MHL control bus (CBUS) when an input event is generated in external device 200. Herein, MHL transceiving driver 194 may receive data from external device 200 and transmit data to external device 200 according to a transmission procedure based on MHL standards. More specifically, MHL transceiving driver 194 may identify an input event type of the received coupling event data and obtain input event data from the received coupling event data, by analyzing the received coupling event data. The obtained input event data may process through: (1) coupling agent 192, (2) input sub-device driver 196, or (3) one of coupling agent 192 and input sub-device driver 196 according to input event types. Herein, input sub-device driver 196 may be a driver configured to process input event data in a kernel layer. Input sub-device driver 196 may include at least one of key input driver 94 for processing a key input data (e.g., keyboard input data), pointing input driver 95 for processing a pointing input data (e.g., mouse input data), and touch input driver 96 (e.g., touch screen input data). At least one embodiment of the present invention, input sub-device driver 196 may be an inter-integrated circuit (I2C) driver. For example, input sub-device driver 196 may include I2C key input driver, I2C pointing input driver, and/or I2C touch input driver. An input event processing procedure in user equipment 100 will be described in more detail with reference to FIGS. 9-10C and FIGS. 12A-12C.

When user equipment 100 is not connected to external device 200, controller 192 may transfer data to be processed in a sub-device, directly to a corresponding sub-device of user equipment 100 instead of transferring the data to coupling agent 192.

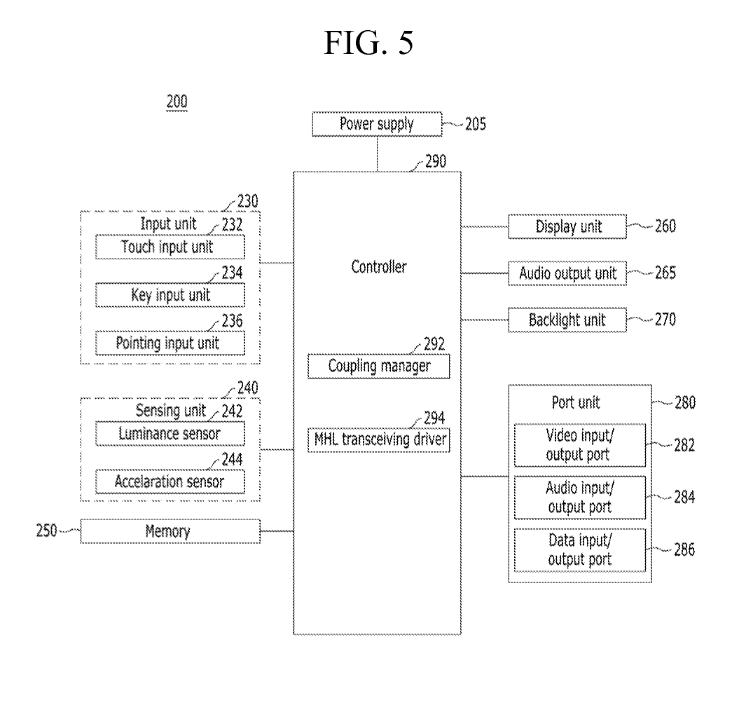

As described above, user equipment 100 may be connected to external device 200 and control external sub-devices of external device 200. External device 200 may perform operation under the control of user equipment 100 after connected to user equipment 100. For example, external device 200 may be a dummy terminal before connected to user equipment 100. When user equipment 100 is connected to external device 200, external device 200 may be activated and perform operations based on control data received from user equipment 100. Furthermore, when input event data (e.g., a keyboard input data) is generated in external device 200 connected to user equipment 100, external device 200 may recognize the generated input event data, create coupling event data including the input event data, and transfer the created coupling event data to user equipment 100. Hereinafter, external device 200 will be described with reference to FIG. 5.

FIG. 5 illustrates an external device in accordance with at least one embodiment of the present invention.

Referring to FIG. 5, external device 200 may include at least one constituent such as power supply 205, input unit 230, sensing unit 240, memory 250, display unit 260, audio output unit 265, backlight unit 270, port unit 280, and controller 290. Herein, a constituent element included in external device 200 may be referred to as a sub-device. However, a constituent element included in external device 200 is hereinafter referred to as an “external sub-device” for convenience. Input unit 230 may include touch input unit 232, key input unit 234, and/or pointing input unit 236 (e.g., a mouse input device). Sensing unit 240 may include luminance sensor 242 and acceleration sensor 244. Controller 290 may include coupling manager 292 and MHL transceiving driver 294. Port unit 280 may include a video input/output port 282, audio input/output unit 284, and data input/output unit 286. As shown, external device 200 may include similar or identical types of constituent elements (e.g., sub-devices) compared to constituent elements (e.g., sub-devices) of user equipment 100. Such constituent elements (i.e., external sub-devices) of external device 200 may be analogous to, and perform similar and/or identical functions to corresponding constituent elements (i.e., sub-devices) of user equipment 100 in accordance with at least one embodiment of the present invention. Corresponding constituent elements of user equipment 100 and external device 200 may be the same type of constituent elements and have the same identification number. For example, display unit 260, audio output unit 265, input unit 230, touch input unit 232, key input unit 234, memory unit 250, and power supply unit 205 may be analogous to and perform similar functions to display unit 160, audio output unit 165, input unit 130, internal memory unit 150, and power supply unit 105 of user equipment 100.

In accordance with at least one embodiment of the present invention, the same types of constituent elements of external device 200 and user equipment 100 may perform similar or identical operations in response to the same types of commands and generate similar or identical events (or, event signals, input/output (I/O) signals, etc.) for the same type of inputs from a user. The events may be generated in response to inputs made by a user. For example, backlight units 170 and 270 of user equipment 100 and external device 200 may emit light in response to the same command such as a turn-on command and may interrupt emitting light in response to the same command such as a turn-off command. Luminance sensors 142 and 242 of user equipment 100 and external device 200 may perform a sensing operation and generate a sensing result value in response to the same command such as a sensing-on command. Furthermore, acceleration sensor 144, touch input unit 132, key input unit 134, memory 150, display unit 160, audio output unit 165 of user equipment 100 may perform similar or identical operations compared to acceleration sensor 244, touch input unit 232, key input unit 234, memory 250, display unit 260, and audio output unit 265 of external device 200.

In order to determine corresponding constituent elements of user equipment 100 and external device 200, user equipment 100 and external device 200 may store and manage (external) sub-device identification information. Furthermore, user equipment 100 and external device 200 may manage the (external) sub-device identification information according to a common management protocol. The constituent element identification information may contain identification numbers of constituent elements of user equipment 100 and external device 200. Such (external) sub-device identification information may be stored in a form of a table. The (external) sub-device identification information may be determined and stored in user equipment 100 and external device 200 by a manufacturer, but the present invention is not limited thereto. Furthermore, the (external) sub-device identification information may be provided from a related server through a communication network. The (external) sub-device identification information may be updated regularly, but the present invention is not limited thereto. Such a (external) sub-device identification table will be described with reference to FIG. 6 in later.

External device 200 may not include all sub-devices that user equipment 100 includes. For example, external device 200 may not include a wireless communication unit and a camera that user equipment 100 includes. In this case, user equipment 100 may still use sub-devices (i.e., a wireless communication unit and a camera) that external device 200 excludes when user equipment 100 is connected to external device 200.

Since the same type of constituent elements of user equipment 100 and external device 200 perform similar and/or identical operations, detailed descriptions of constituent elements performing the same operations will be omitted. Referring back to FIG. 5, port unit 280 and controller 290 of external device 200 will be described hereinafter.

Port unit 280 may be connected to port unit 180 of user equipment 100. That is, port unit 280 may be a connecting port for forming connectivity between user equipment 100 and external device 200. Accordingly, port unit 280 may be a pair relation with port unit 180 of user equipment 100. Port unit 280 may have the same interface configuration of that of port unit 180 of user equipment 100. For example, port unit 280 may have an MHL port.

Particularly, port unit 280 may include video input/output port 282, audio input/output port 284, and data input/output port 286. Video input/output port 282 may receive video data from user equipment 100. Audio input/output port 284 may receive audio signals. Data input/output port 286 may exchange data with user equipment 100. Furthermore, port unit 280 may include a power port (not shown) for transferring an electrical power signal to user equipment 100 and a sensing port (not shown) for sensing connection (e.g., docking) formed between user equipment 100 and external device 200. Such a power port and a sensing port may be included in one of video input/output port 282, audio input/output port 284, and data input/output port 286. The present invention, however, is not limited thereto. For example, the power port and the sensing port may be provided as an independent port. Furthermore, port unit 280 may be connected to user equipment 100 through a radio link formed between user equipment 100 and external device 200. In this case, port unit 280 may include a signal transmitter and receiver (not shown) for communicating with each other using a communication protocol. Such communication protocol may be Bluetooth, but the present invention is not limited thereto.

Referring back to FIG. 2, external device 200 may include coupling bay 251 in accordance with at least one embodiment of the present invention. Port unit 280 may be disposed on one side of coupling bay 251. Coupling bay 251 may be formed at a part of a rear side of external device 200. Coupling bay 215 may have a space for housing user equipment 100. User equipment 100 may be inserted into coupling bay 215. In accordance with at least one embodiment of the present invention, port unit 180 of user equipment 100 may be connected with port unit 280 of user equipment 200 when user equipment 100 is completely inserted into coupling bay 251. The present invention is not limited thereto. Such coupling bay 251 may be formed at any sides of external device 200.

Controller 290 may control operation of external device 200 in overall. Particularly, controller 290 may control constituent elements of external device 200 according to whether the connection is established to user equipment 100 or not. In order to control, controller 290 may include coupling manager 292.

Coupling manager 292 may manage and control operations of external sub-devices of external device 200 in response to user equipment 100 when external device 200 is coupled to user equipment 100. In accordance with at least one embodiment of the present invention, coupling manager 292 may receive control data from user equipment 100 through port unit 280 and perform operation in response to the control data. Furthermore, coupling manager 292 may receive inputs from a related user and transmit the received input to user equipment 100 through port unit 280.

Coupling manager 292 may set up a host-device connection with user equipment 100 when user equipment 100 is connected to external device 200. Accordingly, external device 200 may provide an operation environment identical to that of user equipment 100 when user equipment 100 is connected to external device 200. The operation environment may be a video and audio processing environment and a data input/output environment. That is, a graphic user interface (GUI) displayed on display unit 160 of user equipment 100 is transferred to and displayed on display unit 260 of external device 200 when user equipment 100 is connected to external device 200. In order to perform such operation, coupling manager 292 may activate display unit 260 of external device 200 when connection to user equipment 100 is initially detected. Then, video data may be received from user equipment 100 and the received video data may be output through display unit 260 of external device 200. Coupling manager 292 may transmit information on external sub-devices of external device 200 to user equipment 100 or receive information on sub-devices of user equipment 100 from coupling agent 192 of user equipment 100. Such information may be exchanged through various types of messages.

When input event data (e.g., a keyboard input data) is generated by input unit 230, controller 290 of external device 200 may recognize the generated input event data and transfer the generated input event data to coupling manager 292. Coupling manger 292 may create coupling event data including the input event data, and transfer the created coupling event data to MHL transceiving driver 294. Herein, MHL transceiving driver 294 may transmit data to user equipment 100 and receive data from user equipment 100 according to a transmission procedure based on MHL standards. Particularly, MHL transceiving driver 294 may transmit the transferred coupling event data through MHL control bus (CBUS) to user equipment 100 connected to external device 200. More specifically, when receiving the created coupling event data from coupling manager 292, MHL transceiving driver 294 may transfer the received coupling event data to MHL transceiving driver 194 of user equipment 100 by using a write burst mode, through a control bus (CBUS) line defined in an MHL standard. A coupling event data creation and a coupling event data transmission will be described in more detail with reference to FIG. 9 to FIG. 11.

In accordance with at least one embodiment of the present invention, external device 200 may not operate in a disconnected status. The disconnected status may denote that user equipment 100 is not connected to external device 200. Accordingly, in this case, external device 200 may be a dummy device. In this case, external device 200 may include minimum elements for performing essential functions such as display control and touch input control. Accordingly, a comparatively cheap external device including the minimum elements may provide a user with an operation environment identical to that of an external device having a comparatively high performance such as a laptop computer, a tablet PC, or a pad-type device. The present invention, however, is not limited thereto. External device 200 may be embodied as an independent device installed with an operating system (OS) that allows external device 200 to operate in a standalone device. For example, external device 200 may operate as a moving image player or a MP3 player when external device 200 is not coupled to user equipment 100. When external device 200 is coupled to user equipment 100, external device 200 may perform certain operations of user equipment 100 in response to the control of user equipment 100 in accordance with at least one embodiment of the present invention.

As described above, user equipment 100 and external device 200 may determine the same type of constituent elements based on the (external) sub-device identification table. The (external) sub-device identification table may include information on identification numbers of constituent elements of user equipment 100 and/or external device 200. Such a (external) sub-device identification table will be described with reference to FIG. 6.

FIG. 6 illustrates a (external) sub-device identification table in accordance with at least one embodiment of the present invention.

Referring to FIG. 6, user equipment 100 may include sub-device identification table 6100, and external device 200 may include external sub-device identification table 6200 in accordance with at least one embodiment of the present invention. As shown in FIG. 6, when sub-devices of user equipment 100 and external sub-devices of external device 200 have the same identification numbers, such (external) sub-devices are the same type of constituent elements. That is, when (external) sub-devices having the same identification number, such (external) sub-devices may perform similar or substantially identical operations in response to the same command and/or the same event generated in response to a user input. For example, audio output units of user equipment 100 and external device 200 may have the same identification number of “9”. Furthermore, acceleration sensors of user equipment 100 and external device 200 may have the same identification number of “5”. Similarly, luminance sensors, touch screens, display units, internal memory, external memory, and backlight units of user equipment 100 and external device 200 may have the same identification numbers of 4, 7, 8, 10, 11, and, 12. These (external) sub-devices may perform about the identical operation in response to the same events.

Such (external) sub-device identification tables 6100 and 6200 may be exchanged between user equipment 100 and external device 200 when user equipment 100 is connected to external device 200. Accordingly, each of user equipment 100 and external device 200 may determine corresponding (external) sub-devices (i.e., corresponding constituent elements) of connected device based on (external) sub-device identification tables 6100 and/or 6200. For example, user equipment 100 may recognize constituent elements (i.e., external sub-devices) included in external device 200 and common constituent elements included in both user equipment 100 and external device 200, by comparing identification numbers.

External device 200 may include some constituent elements of user equipment 100 and further include other constituent elements not being included in user equipment 100. For example, wireless communication unit 110 and A/V capturing unit 120 (e.g., a microphone and a camera) of user equipment 100 may not be included in external device 200. In this case, wireless communication unit 110 and A/V capturing unit 120 of user equipment 100 may be able to operate regardless of whether or not user equipment 100 is connected to external device 200.

As described above, external device 200 may be connected to user equipment 100 and perform operations under the control of user equipment 100 in accordance with at least one embodiment of the present invention. Such operation may be performed by exchanging data through port units 180 and 280. Such port units 180 and 280 may be illustrated in FIGS. 7A and 7B. For convenience and ease of understanding, port unit 180 of user equipment 100 is representatively shown in FIGS. 7A and 7B. Port unit 280 of external device 200 may have the same configuration of port unit 180 of user equipment 100.

FIGS. 7A and 7B illustrate a port unit of user equipment in accordance with at least one embodiment of the present invention.

Referring to FIG. 7A and FIG. 7B, port unit 180 of user equipment 100 may include an MHL port such as MHL port 710 or μ-MHL port 720. Herein, MHL port 710 and μ-MHL port 720 may include 11 pins and 5 pins respectively for exchanging signals designated to each pin. Particularly, an MHL transmission using MHL port 710 or μ-MHL port 720 may simultaneously transmit video signal, audio signal, and data signal through a single physical connection.

For example, MHL port 710 and μ-MHL port 720 may include 5V power pin. User equipment 100 may receive an electrical power signal from external device 200 through 5V power pin when user equipment 100 is connected to external device 200. Such electrical power signal may be supplied in order to enable user equipment 100 to detect physical connection to external device 200. As described above, external device 200 may have the same MHL port 710 or μ-MHL port 720 in accordance with at least one embodiment of the present invention.

When receiving an electrical power signal from external device 200, user equipment 100 may determine that user equipment 100 is successfully connected to external device 200. Furthermore, TMDS port may mainly exchange video data and audio data with external device 200. USB port may include two pins for mainly exchanging data with external device 200. Ctrl Bus (CBUS) port may include one pin for typically exchanging control data with external device 200. Although FIG. 7A and FIG. 7B show port unit 180 having MHL port 710 or μ-MHL port 720 to connect user equipment 100 with external device 200, the present invention is not limited thereto.

In accordance with at least one embodiment of the present invention, user equipment 100 is coupled to external device 200 though port unit 180. The present invention, however, is not limited thereto. For example, user equipment 100 may be coupled to other electronic devices or appliances such as TV and computer monitors having MHL port 710 or μ-MHL port 720 to output signals (e.g., audio/video/data/control signals) thereto.

In accordance with at least one embodiment of the present invention, user equipment 100 may use external sub-devices of external device 200 to perform certain operation such as outputting video and audio data and receiving input from a user after user equipment 100 is coupled to external device 200. In order to use the external sub-devices of external device 200, user equipment 100 may establish a connection to external device 200, exchange (external) sub-device identification information (6100, 6200) with external device 200, and reconfigure a control path to control constituent elements of external device 200. Hereinafter, a method of establishing a connection between user equipment 100 and external device 200 in order to control external device 200 through user equipment 100 in accordance with at least one embodiment of the present invention will be described with reference to FIG. 8.

Meanwhile, in accordance with at least one embodiment of the present invention, user equipment 100 may process an input event generated from external device 200. More specifically, when input event data are generated by input unit 230, external device 200 may create coupling event data (i.e., a coupling event data frame) including the generated input event data and transmit the created coupling event data to user equipment 100 through Ctrl Bus (CBUS) port. When receiving the coupling event data from external device 200, user equipment 100 may obtain input event data from the received coupling event data, and process the obtained input event data to a corresponding input device diver such as a keyboard driver, a mouse driver, or a touch pad driver. Hereinafter, a method of processing an input event generated in external device in accordance with at least one embodiment of the present invention will be described with reference to FIG. 9 to FIG. 12.

For convenience and ease of understanding, the method will be described as establishing the connection in a physical manner such as a docking manner or a cable (e.g., an MHL cable). The present invention, however, is not limited thereto. Such connection may be established in various manners. For example, user equipment 100 may be coupled to external device 200 through a wireless link.

FIG. 8 illustrates establishing a connection between user equipment and an external device in accordance with at least one embodiment of the present invention. More specifically, FIG. 8 illustrates establishing a connection between user equipment 100 and external device 200 in order to control external device 200 through user equipment 100 or process an input event generated from external device 200.

Referring to FIG. 8, user equipment 100 and external device 200 may be in a disconnected state when user equipment 100 is not connected to external device 200 at steps S800 and S801. Particularly, coupling agent 192 of user equipment 100 and coupling manager 292 of external device 200 may manage states related to a connection established between user equipment 100 and external device 200. In accordance with at least one embodiment, user equipment 100 and external device 200 may have at least one of states related to establishment of the connection. For example, the states may include a disconnected state, a connecting state, and a connected state. Herein, the disconnected state may denote a state that a connection between user equipment 100 and external device 200 is not established. The connecting state may denote a state that a data connection between user equipment 100 and external device 200 is being established. The connected state may denote a state that a data connection between user equipment 100 and external device 200 is already established.

At step S802, an electrical power signal may be transmitted from external device 200 to user equipment 100 when external device 200 is connected to user equipment 100. Herein, the electrical power signal may be an MHL 5V power signal transmitted through a 5V power pin of port units 180 and 280. In at least one embodiment of the present invention, external device 200 may transmit a first electrical signal through a specific pin (other than the 5V power pin) of port unit 280 when external device 200 is physically connected to user equipment 100.

At step S804, user equipment 100 may determine whether external device 200 is physically connected to user equipment 100, based on detection of the electrical power signal transmitted by external device 200. For example, port unit 180 of user equipment 100 and port unit 280 of external device 200 may be connected through a physical cable such as an MHL cable as shown in FIG. 3(d). In order to connect user equipment 100 to external device 200 through the MHL cable, user equipment 100 and external device 200 may include MHL port 710 or μ-MHL port 720 as port units 180 and 280 as shown in FIG. 7A and FIG. 7B. External device 200 may include the same port (e.g., MHL port 710 or μ-MHL port 720) as port unit 280 as shown in FIG. 5. When user equipment 100 is placed in coupling bay 251 of external device 200, or user equipment 100 is connected to external device 200 through the MHL cable, MHL port 710 (or μ-MHL port 720) of user equipment 100 is connected to the same MHL port 710 (or μ-MHL port 720) of external device 200.

Meanwhile, external device 200 may be configured to supply power through 5V power pin as shown in FIGS. 7A and 7B. Accordingly, when user equipment 100 is connected to external device 200, electrical power may be supplied to user equipment 100, as an electrical signal (S802), through 5V power pin. Herein, the electrical power signal may enable user equipment 100 to recognize that external device 200 is connected to user equipment 100. In the case that a physical connection between user equipment 100 and external device 200 is established through the MHL cable, external device 200 may determine that user equipment 100 is connected to external device 200 when an electrical power signal is transmitted from external device 200 to user equipment 100, i.e., when power charging of user equipment 100 is detected.

In at least one embodiment of the present invention, user equipment 100 may transmit a response signal (i.e., a second electrical signal) (not shown in FIG. 8) to external device 200 when receiving the first electrical signal or the electrical power signal from external device 200. User equipment 100 may transmit the response signal through a specific pin (other than 5V power pin) of port unit 180. Meanwhile, the response signal may be generated in hardware manner in accordance with embodiments of the present invention. For example, port unit 180 of user equipment 100 may be configured to return a part of power supplied through a 5V power pin back to external device 200. In this case, external device 200 may determine that external device 200 is connected to user equipment 100 when receiving the response signal from user equipment 100. In other words, the response signal may enable user equipment 100 to recognize that physical connection is successfully established to external device 200.

At step S806, when recognizing the physical connection with user equipment 100 as described above, external device 200 may transit from the disconnected state to a connecting state. For example, when the electrical power signal is transmitted (i.e., when the electrical power is supplied) to user equipment 100, or when the response signal is received from user equipment 100, external device 200 may perform a state change procedure. More specifically, coupling manager 292 of external device 200 may transit from the disconnected state to the connecting state.

At step S808, user equipment 100 may transit from the disconnected state to a connecting state when detecting the electrical power signal transmitted by external device 200 (Yes—S804). More specifically, coupling agent 192 of user equipment 100 may transit from the disconnected state to the connecting state. In at least one embodiment of the present invention, user equipment 100 may transit from the disconnected state to a connecting state when detecting a specific electrical signal (other than an electrical power signal) transmitted by external device 200.

At step S810, user equipment 100 may transmit a connection initiation message to external device 200 in order to continue to perform a data connection between user equipment 100 and external device 200. Herein, the data connection may enable user equipment 100 and external device 200 to exchange data.

At step S812, when receiving the connection initiation message from user equipment 100, external device 200 may transmit an acknowledge (ACK) message in response to the received connection initiation message. Thereafter, external device 200 may continue to perform the data connection.

At step S814, external device 200 may transmit external sub-device information to user equipment 100 such that user equipment 100 may obtain information on external sub-devices included in external device 200. Herein, the external sub-device information may denote information of constituent elements (i.e., sub-devices) of external device 200. Furthermore, the external sub-device information may be provided in the form of an external sub-device identification table (“6200”) as shown in FIG. 6, or a specific information list. The present invention, however, is not limited thereto. the external sub-device information may include a list of external sub-devices and corresponding identification numbers. The constituent elements (i.e., sub-devices) of external device 200 may be a microphone, a sensor, keypad input unit, a touch screen, a display unit, an audio output unit, and so forth.

At step S816, when receiving the external sub-device information from external device 200, user equipment 100 may select at least one external sub-device (i.e., at least one controllable sub-device included in external device 200) to be controlled or used by user equipment 100, using the received external sub-device information. The selected external sub-devices will be used instead of sub-devices of user equipment 100 when external device 200 is connected to user equipment 100.

At step S818, user equipment 100 may transmit information on the selected at least one external sub-device to external device 200. Herein, the information on the selected at least one external sub-device may include identification numbers associated with the selected external sub-devices.

At step S820, external device 200 may transmit a connection completion message to user equipment 100 when receiving the selected at least one external sub-device from user equipment 100.

At step S822, user equipment 100 may obtain operation setting information on at least one sub-device (i.e., at least one sub-device included in user equipment 100) corresponding to the selected external sub-device. The sub-devices corresponding to the selected external sub-devices may have the same type of sub-devices. For example, the corresponding sub-devices of user equipment 100 may have the same identification number of the selected external sub-devices. The operation setting information may be information on settings of corresponding sub-devices performing certain operations. That is, the operation setting information may include information on setting properties such as a volume level, a power on/off state, a brightness level, and likes.

At step S824, user equipment 100 may transmit the obtained operation setting information to external device 200.

At step S826, when receiving the operation setting information, external device 200 may change operation setting associated with corresponding external sub-devices, based on the received operation setting information. For example, the operation settings of corresponding external sub-devices of external device 200 may be synchronized with the operation settings of the sub-devices of user equipment 100, based on the received operation setting information. That is, the sub-devices of user equipment 100 and the external sub-devices of external device 200 may be synchronized in operation state. For example, in the case that audio output unit 165 of user equipment 100 is set up with a volume level of “1” before user equipment 100 is connected to external device 200, corresponding audio output unit 265 of external device 200 may be synchronized to be set with the volume level of “1” when user equipment 100 is connected to external device 200. Accordingly, sub-devices of user equipment 100 and external sub-devices of external device 200 may be operated according to identical settings. Users may not need to reconfigure an operation setting of external sub-devices of external device 200 after user equipment 100 is connected to external device 200.

At step S828, user equipment 100 may reconfigure a control path of sub-devices. For example, a control path of controlling sub-devices of user equipment 100 may be reconfigured to control corresponding external sub-devices of external device 200 after user equipment 100 is connected to external device 200. That is, a control path of sub-devices may be reconfigured such that a function performed by a sub-device of user equipment 100 in a disconnected state may be performed by a corresponding external sub-device of external device 200 after user equipment 100 is connected to external device 200. Control of sub-devices may include event control and command control. Herein, the event control may be operations for controlling and processing an event generated in sub-devices or external sub-devices. The event may be an event signal generated in response to inputs from a user. The command control may be operations for instructing sub-devices or external sub-devices to perform a specific operation.

In the case that user equipment 100 is not connected to external device 200, sub-devices of user equipment 100 may generate events in response to inputs from a user, and the generated events may be transferred to controller 190. However, after user equipment 100 is connected to external device 200, external sub-devices of external device 200 may generate events in response to inputs from a user, and the generated events may be required to be transferred to user equipment 100 (more specifically, controller 192 of user equipment 100). Accordingly, user equipment 100 may need to reconfigure an event control path such that an event generated in external sub-devices of external device 200 may be received in user equipment 100 and the generated event may be transferred to controller 192 of user equipment 100.

In the case that user equipment 100 is not connected to external device 200, user equipment 100 may transmit a certain command generated by controller 192 to a corresponding sub-device of user equipment 100. However, after user equipment 100 is connected to external device 200, user equipment 100 may need to reconfigure a command control path such that a certain command generated by controller 192 may be transmitted to a corresponding external sub-device of external device 200.

Such reconfiguration of control path may be performed by coupling agent 192 in accordance with embodiments of the present invention. For example, after user equipment 100 is connected to external device 200, coupling agent 192 may receive data generated in controller 190 of user equipment 100, including commands and/or control data and transfer the received data to external device 200 through port unit 180. Furthermore, coupling agent 192 may receive events generated in external sub-devices of external device 200 after user equipment 100 is connected to external device 200. Coupling agent 192 may transfer the received event to controller 190 of user equipment 100. In the case that the received event is an input event, MHL transceiving driver 194 and/or coupling agent 192 may process the received input event according to types of the input event. An input event processing procedure will be described in more detail with reference to FIG. 9 to FIG. 12.

When user equipment 100 is not connected to external device 200, controller 192 may transfer data to be processed in a sub-device, directly to a corresponding sub-device of user equipment 100 instead of transferring the data to coupling agent 192.

At step S830, sub-devices of user equipment 100 may be inactivated after reconfiguring control path. For example, user equipment 100 may suspend the sub-devices or power off the sub-devices. In at least one embodiment of the present invention, sub-devices of user equipment 100 may keep being activated.

At step S832, user equipment 100 may transmit a connection completion ACK message to external device 200 in order to inform external device 200 that the data connection to external device 200 is complete. Thereafter, at step S834, user equipment 100 may transit from the connecting state to a connected state.

Meanwhile, at step S836, external device 200 may start outputting information in response to the control of user equipment 100. For example, external device 200 may start receiving video and/or audio data from user equipment 100 with control data and start outputting the received video and/or audio data through related external sub-devices of external device 200. External device 200 may receive MHL signals from user equipment 100 and display the received MHL signals on display unit 260 of external device 200.

At step S838, external device 200 may transit from the connecting state to a connected state. More specifically, in response to the connection completion ACK message (S830) received from user equipment 100, external device 200 may transit to the connected state. In at least one embodiment of the present invention, such state transition operation may be performed simultaneously at the step S836 or before starting outputting the received information at the step S836.

As described above, when user equipment 100 is connected to external device 200, the control path may be reconfigured to control external sub-devices of external device 200 instead of controlling corresponding sub-devices of user equipment 100. When user equipment 100 is disconnected from external device 200, such a control path may need to reconfigured back to an original control path.

In at least one embodiment of the present invention, state transition operations and/or transmission operations of connection rated messages (e.g., a connection initiation message, a connection completion message, and ACK messages) may be omitted.

Meanwhile, user equipment 100 may sense releasing from external device 200 when user equipment 100 is disconnected from external device 200. In this case, user equipment 100 may restore an original control path for controlling sub-devices of user equipment 100 instead of controlling external sub-devices of external device 200. Furthermore, user equipment 100 may transit from the connected state to a connection release state. In the case that external device 200 senses releasing from user equipment 100, external device 200 may inactivate external sub-devices of external device 200. For example, external device 200 may turn off or suspend external sub-devices of external device 200. Furthermore, external device 200 may transit from the connected state to the connection release state.

FIG. 9 illustrates processing an input event generated in external device 200 in accordance with at least one embodiment of the present invention. More specifically, user equipment 100 may process the input event which is generated in external device 200 and is transferred to user equipment 100. For convenience and ease of understanding, the method of processing the input event will be described in the case that user equipment 100 uses an Android™ operating system (OS) including a plurality of layers such as kernel, libraries, framework, and applications, but the present invention is not limited thereto.

Referring to FIG. 9, in the case that a connection between user equipment 100 and external device 200 is established through a connection procedure as shown in FIG. 8, an input event may be generated from input unit 230 such as touch input unit 232 (e.g., a touch screen), key input unit 234 (e.g., a keyboard), and/or pointing input unit 236 (e.g., a mouse device, a keypad, etc.).

At step S900, the generated input event data may be transferred to coupling manager 292 corresponding to an application layer. For example, in the case that a user inputs text data using a keyboard, the text data may correspond to the input event data.

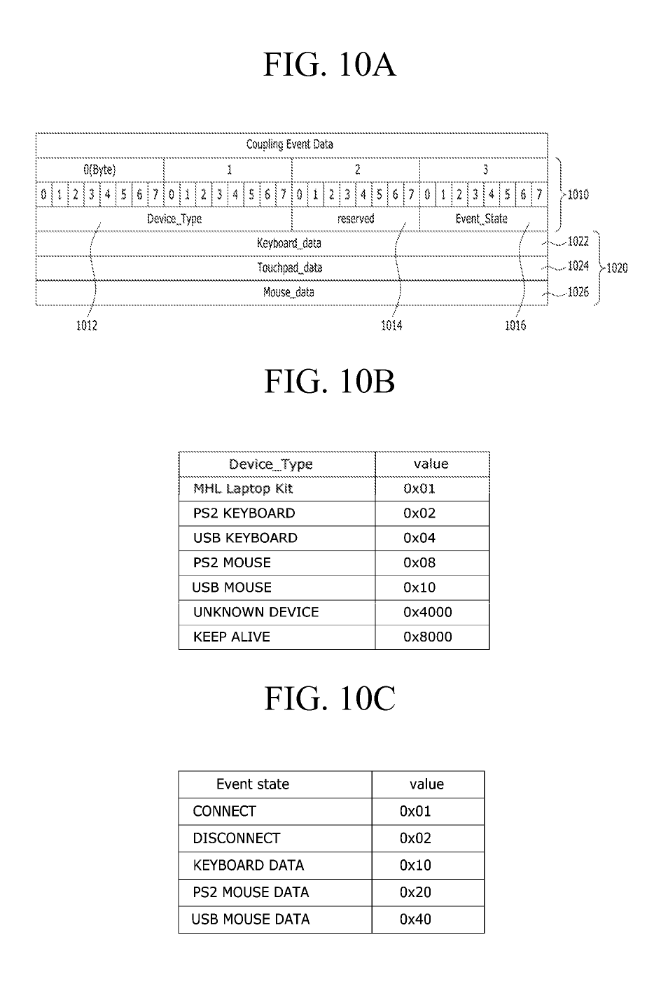

When receiving the input event data, coupling manager 292 may create coupling event data (i.e., a coupling event data frame) based on the received input event data such that the received input event data may be transmitted to user equipment 100 according to an MHL transmission procedure. Hereinafter, a frame structure of the coupling event data will be described in detail with reference to FIG. 10A to FIG. 10C.

At step S902, coupling manager 292 may transmit the created coupling event data to a first MHL transceiving driver such as MHL transceiving driver 294.

At step S904, when receiving the created coupling event data, MHL transceiving driver 294 may transfer the received coupling event data to user equipment 100 (more specifically, a second MHL transceiving driver such as MHL transceiving driver 194). For example, MHL transceiving driver 294 may transfer the received coupling event data to MHL transceiving driver 194 by using a write burst mode, through a control bus (CBUS) line defined in an MHL standard. In the write burst mode, MHL transceiving driver 294 may transfer data in a single burst transaction.

MHL transceiving driver 294 of external device 200 may optimally determine a data transmission period (e.g., 15 msec) of the received coupling event data to be transferred to MHL transceiving driver 194, based on a data interrupt processing speed in user equipment 100. Herein, the data interrupt processing speed may indicate a speed at which user equipment 100 recognizes and processes a corresponding interrupt when coupling event data is transferred to MHL transceiving driver 194 of user equipment 100. Such interrupt processing speed may be different according to a central processing unit (CPU) performance of user equipment 100. When a transmission speed of the coupling event data transmitted by MHL transceiving driver 294 of external device 200 is comparatively high, user equipment having a comparatively low performance may not process a corresponding coupling event data.

Meanwhile, in the case that an input event is a keyboard input event, a data input speed of the keyboard input event may be higher than a data transmission speed of coupling event data. In this case, it may be possible to lose data since a new coupling event data may be received in the middle of the transmission of coupling event data to user equipment 100. Accordingly, in at least one embodiment of the present invention, external device 200 may include at least one queue (not shown) to temporally store coupling event data to transfer to user equipment 100. MHL transceiving driver 294 of external device 200 may sequentially store a plurality of coupling event data (i.e., coupling event data frame) received coupling manager 292, in the at least one queue. MHL transceiving driver 294 of external device 200 may sequentially transmit the stored coupling event data to MHL transceiving driver 194 of user equipment 100.

MHL transceiving driver 194 of user equipment 100 may receive coupling event data through the CBUS line from MHL transceiving driver 294 of external device 200 at step S904.

When receiving the coupling event data from MHL transceiving driver 294, MHL transceiving driver 194 may analyze the received coupling event data, and obtain input event data from input event data field 1020. Furthermore, MHL transceiving driver 194 may identify types of input sub-devices, connection state information (e.g., whether an external sub-device is connected to external device 200, and/or whether or not user equipment 100 is connected to external device 200), and/or information on a presence of input event data from header 1010. MHL transceiving driver 194 of user equipment 100 may transfer the obtained input event data to input sub-device driver 196 or coupling agent 192.

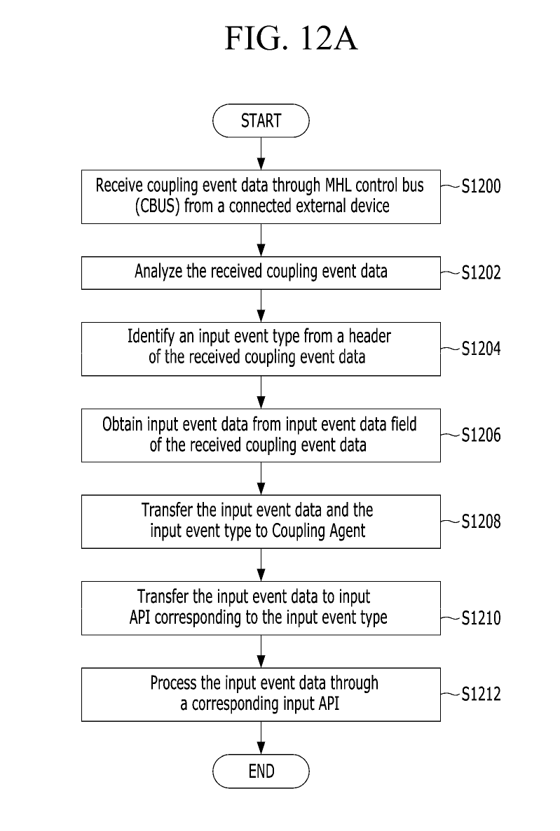

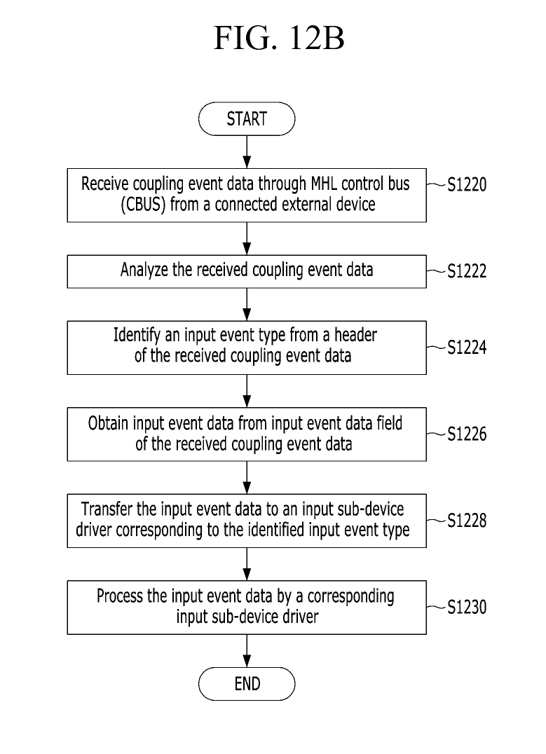

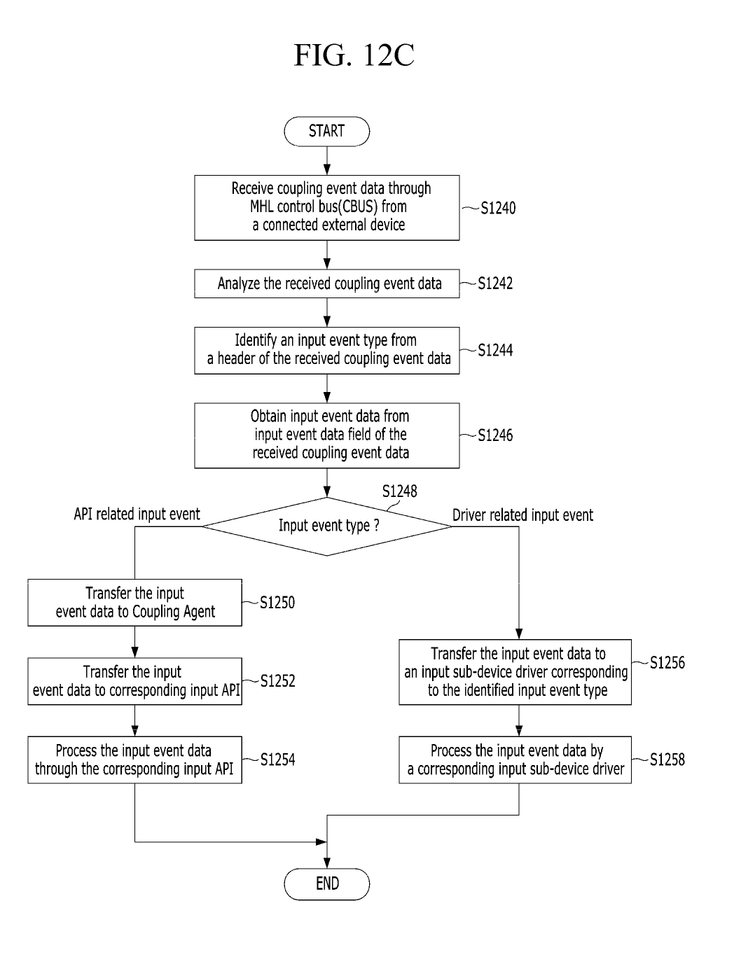

In at least one embodiment of the present invention, at step S906, MHL transceiving driver 194 of user equipment 100 may transfer the obtained input event data to coupling agent 192. Furthermore, MHL transceiving driver 194 may include at least one queue (not shown) which can temporally store input event data to be transferred to coupling agent 192. In this case, MHL transceiving driver 194 may sequentially store a plurality of input event data obtained from the received coupling event data, in the at least one queue. MHL transceiving driver 194 may sequentially transmit the stored input event data to coupling agent 192. When receiving the input event data from MHL transceiving driver 194, coupling agent 192 may transfer the received input event data to a corresponding input sub-device application programming interface (API) at steps S908 to S912. Herein, the input sub-device API may be referred to as “input API.” The input sub-device API (i.e., input API) may include at least one of key input sub-device API 91 (i.e., a key input API) such as a keyboard API, pointing input sub-device API 92 (i.e., a pointing input API) such as a mouse API or a touch pad API, and touch input sub-device API 93 (i.e., a touch input API) such as a touch screen API. For example, coupling agent 192 may transfer key input event data (e.g., keyboard input data) to key input sub-device API 91 at step S908. Coupling agent 192 may transfer pointing input event data (e.g., mouse input data) to pointing input sub-device API 92 at step S910. Coupling agent 192 may transfer touch input event data (e.g., touch screen input data) to touch input sub-device API 93 at step S912. When receiving input event data from coupling agent 192, each of input sub-device APIs 91 to 93 may process the received input event data. Such procedure processing the coupling event data through coupling agent 192 as described above will be described in more detail with reference to FIG. 12A.

In at least one embodiment of the present invention, user equipment 100 may include at least one input sub-device driver. For example, user equipment 100 may include at least one of key input sub-device driver 94 (i.e., a key input driver) such as a keyboard driver, pointing input sub-device driver 95 (i.e., a pointing input driver) such as a mouse driver or a touch pad driver, and touch input sub-device driver 96 (i.e., a touch input driver) such as a touch screen driver. In this case, MHL transceiving driver 194 may directly transfer the obtained input event data to a corresponding input sub-device driver in order to achieve an efficient data transmission at step S914 to S918. For example, MHL transceiving driver 194 may transfer key input event data (e.g., keyboard input data) to key input sub-device driver 94 at step S914. MHL transceiving driver 194 may transfer pointing input event data (e.g., mouse input data) to pointing input sub-device driver 95 at step S916. MHL transceiving driver 194 may transfer touch input event data (e.g., touch screen input data) to touch input sub-device driver 96 at step S918. When receiving input event data from MHL transceiving driver 194, each of input sub-device drivers 94 to 96 may process the received input event data. Such procedure processing the coupling event data through input sub-device driver 196 as described above will be described in more detail with reference to FIG. 12B.

In at least one embodiment of the present invention, user equipment 100 may include at least one input API and at least one input driver. For example, user equipment 100 may include key input API 91 (e.g., a keyboard API), pointing input sub-device driver 95 (e.g., a mouse driver, a touch pad driver, etc.), and touch input sub-device driver 96 (e.g., a touch screen driver). In this case, MHL transceiving driver 194 of user equipment 100 may transfer a key input event data among the obtained input event data to coupling agent 192 at step S906. When receiving the key input event data from MHL transceiving driver 194, coupling agent 192 may transfer the received key input event data to key input sub-device API 91 at step S908. Meanwhile, MHL transceiving driver 194 may directly transfer a pointing input event data and a touch input event data among the obtained input event data to a corresponding input sub-device driver at step S916 and S918. More specifically, MHL transceiving driver 194 may transfer a mouse input event data to mouse input sub-device driver 95 at step S916. MHL transceiving driver 194 may transfer a touch input event data to touch input sub-device driver 96 at step S918. Accordingly, key input sub-device API 91, mouse input sub-device driver 95, and touch input sub-device driver 96 may process corresponding input event data. Such procedure processing the coupling event data through one of coupling agent 192 and an input sub-device driver 196 according to input event types as described above will be described in more detail with reference to FIG. 12C.

When the input event data is processed by an input sub-device API or an input sub-device driver, input event processing results may be displayed in user equipment 100. User equipment 100 may transfer the input event processing results to external device 200, using a reconfigured control path as described in FIG. 8. External device 200 may display the input event processing results using display unit 260.

FIGS. 10A to 10C illustrate a structure of a coupling event data frame in accordance with at least one embodiment of the present invention. For example, in the case that external device 200 is an MHL laptop kit including a keyboard, a touch pad, a USB mouse, MHL ports, and a display unit, the coupling event data may be defined as shown FIGS. 10A to 10C. Herein, the touch pad may be recognized as a PS2 mouse.

Referring to FIG. 10A, a coupling event data frame may have a total size of about 16 bytes and include header field 1010 and input event data field 1020. The coupling event data frame may simply be referred to as “coupling event data.” Herein, header filed 1010 may have a size of about 4 bytes and include device_type field 1012, reserved field 1014, and event_state field 1016. Sometimes, sub-device types of user equipment 100, external sub-device types of external device 200, and device types of external device 200 may collectively be referred to as “device types” for convenience.

A structure and/or a size of the coupling event data frame may be determined based on at least one of a data transmission amount and a data transmission period, for an efficient transmission of the coupling event data. For example, in order to transmit a large amount of data, the structure of the coupling event data frame may be simplified such that a wider data space may be secured. More specifically, device_type field 1012 and event_state field 1016 may be reduced, and the remained space including the reserved field may be filled with substantial input data.

In the case that external device 200 is the MHL laptop kit, a device type, an event state, and values thereof may be defined as shown in FIGS. 10B and 10C. In the case that external device 200 is a different device from the MHL laptop kit, device types, event states, and values thereof may be differently defined. Herein, device_type field 1012 may indicate a type of external device and/or types of sub-devices. For example, in the case that external device 200 is MHL laptop kit, a corresponding identification number of is defined as “0x01” (refer to FIG. 10B). In this case, external sub-devices (e.g., PS2 keyboard, USB keyboard, etc.) of MHL laptop kit may be defined as shown in FIG. 10B. Furthermore, device_type field 1012 may indicate a property of a corresponding input event to be processed. That is, a property of an input event may be recognized based on device types. For example, input event types (e.g., a key input event, a pointing input event, or a touch input event) may be recognized from device_type field 1012.

Referring to FIG. 10C, event_state field 1016 may include information and connection state and/or a presence of input event data such that MHL transceiving driver 194 of user equipment 100 efficiently reads the received input event data. Herein, the connection state information may indicate whether user equipment 100 is connected to external device 200, and/or whether external sub-devices (e.g., a USB mouse) of external device 200 are connected to external device 200. The information associated with the presence of the input event data may indicate whether or not input event data to be transmitted is included in “input event data” field 1020, and/or properties (e.g., keyboard data) of the included input event data.

In the case that external device 200 is the MHL laptop kit, input event data field 1020 may have a size of about 12 bytes, and include “keyboard_data” field 1022, “touchpad_data” field 1024, and “mouse_data” field 1026 as shown in FIG. 10A. Herein, “keyboard_data” field 1022, “touchpad_data” field 1024, and “mouse_data” field 1026 may have a size of about 4 bytes, respectively. In at least one embodiment of the present invention, an input event data field of a coupling event data frame may include at least one of a key input data field, a pointing input data field, and a touch input data field. Accordingly, in the case that the MHL laptop kit further includes a touch screen as an external sub-device, device types and event state may further include identification values associated with the touch screen. In this case, the touch input data field may have more than 4 bytes in field size because touch input data may have a comparatively large amount of data. In at least one embodiment of the present invention, input event data field 1020 may include a plurality of input data types. For example, in the case that external device 200 is the MHL laptop kit, and a keyboard input event and a mouse input event are simultaneously generated, a coupling event data frame may include keyboard input data and mouse input data. More specifically, in this case, the keyboard input data may be included in keyboard_data” field 1022, and the mouse input data may be included in “mouse_data” field 1026.

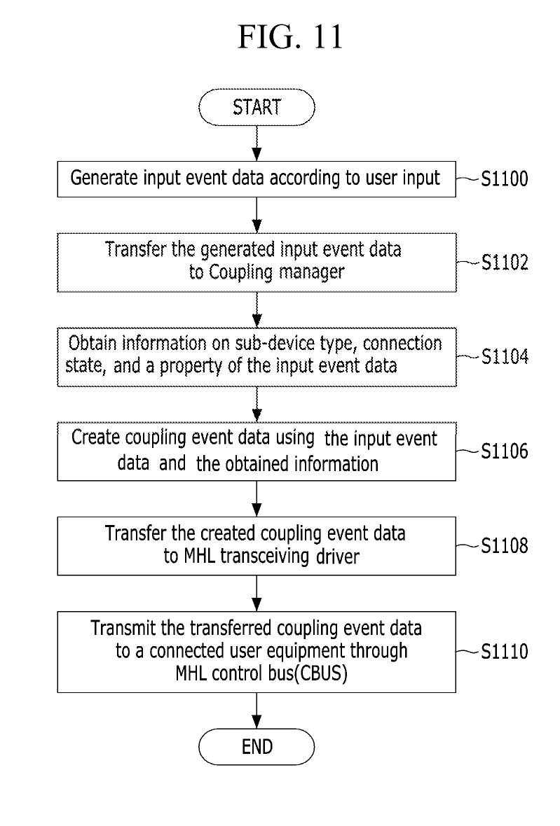

FIG. 11 illustrates creating a coupling event data in an external device and transmitting the created coupling event data to user equipment in accordance with at least one embodiment of the present invention.

Referring to FIG. 11, input unit 230 of external device 200 may generate input event data (e.g., keyboard input data) according to user input at step S1100. For example, in the case that a user inputs certain characters through a keyboard of external device 200, the inputted characters may be the input event data.

At step S1102, when the input event data is generated, controller 290 of external device 200 may recognize the generated input event data and transfer the generated input event data to coupling manager 292.

At step S1104, coupling manager 292 may obtain information on a sub-device type (e.g., a USB keyboard) of corresponding external sub-device, connection state information (e.g., whether or not the USB keyboard is connected to external device 200) and/or a property (e.g., keyboard data) of the input event data. In at least one embodiment of the present invention, controller 290 of external device 200 may obtain the information and provide the obtained information to coupling manager 292.

At step S1106, coupling manager 292 may create coupling event data (more specifically, a coupling event data frame) using the transferred input event data and the obtained information. Particularly, coupling manager 292 may create the coupling event data such that the input event data may be transmitted to user equipment 100 according to an MHL transmission procedure. For example, the coupling event data may header field 1010 and input event data field 1020. Herein, the transferred input event data may be included in input event data field 1020, and the obtained information may be included in header field 1010. Since a frame structure of the coupling event data was already described with reference to FIG. 10A to FIG. 10C, the detailed description thereof is omitted.

At step S1108, coupling manager 292 may transfer the created coupling event data to MHL transceiving driver 294.

At step S1110, MHL transceiving driver 294 may transmit the transferred coupling event data through MHL control bus (CBUS) to user equipment 100 connected to external device 200. More specifically, when receiving the created coupling event data from coupling manager 292, MHL transceiving driver 294 may transfer the received coupling event data to MHL transceiving driver 194 of user equipment 100 by using a write burst mode, through a control bus (CBUS) line defined in an MHL standard.

FIG. 12A to FIG. 12C illustrate processing a coupling event data in user equipment 100 in accordance with at least one embodiment of the present invention. More specifically, user equipment 100 may receive the coupling event data from external device 200, through MHL control bus (BUS). In this case, FIG. 12A to FIG. 12C illustrate processing the received coupling event data through: (1) coupling agent 192, (2) input drivers (i.e., input sub-device drivers), or (3) one of coupling agent 192 and an input driver according to input event types.

FIG. 12A illustrates processing the coupling event data through coupling agent 192.

Referring to FIG. 12A, user equipment 100 may receive a coupling event data through MHL control bus (CBUS) from a connected external device 100 at step S1200. More specifically, MHL transceiving driver 194 of user equipment 100 may receive the coupling event data MHL control bus (CBUS) from MHL transceiving driver 294 of external device 200 connected to user equipment 100.

At step S1202, MHL transceiving driver 194 may analyze the received coupling event data. Herein, the received coupling event data may header field 1010 and input event data field 1020. Since a frame structure of the received coupling event data was already described with reference to FIG. 10A to FIG. 10C, the detailed description thereof is omitted.

At step S1204, MHL transceiving driver 194 may identify an input event type from header 1010 of the received coupling event data, based on the analysis results. Herein, the input event type may be one of a key input event (e.g., a keyboard input event), a pointing input event (e.g., a mouse input event, a touch pad input event, etc.), and a touch input event (e.g., a touch screen input event).

At step S1206, MHL transceiving driver 194 may obtain input event data from input event data field 1020 of the received coupling event data, based on the analysis results.

At step S1208, MHL transceiving driver 194 may transfer the obtained input event data and the identified input event type to coupling agent 192.

At step S1210, when receiving the obtained input event data and the identified input event type from MHL transceiving driver 194, coupling agent 192 may transfer the received input event data to input API corresponding to the received input event type information. For example, coupling agent 192 may transfer key input event data (e.g., keyboard input data) to key input API 91. Coupling agent 192 may transfer pointing input event data (e.g., mouse input data) to pointing input API 92. Coupling agent 192 may transfer touch input event data (e.g., touch screen input data) to touch input API 93.

At step S1212, the input event data may be processed through a corresponding input API. That is, when receiving input event data from coupling agent 192, a corresponding input API of input APIs 91 to 93 may process the received input event data. For example, in the case of that the received input event data is a keyboard input data, key input API 91 may process the keyboard input data.

When the input event data is processed by a corresponding input sub-device API, input event processing results may be displayed in user equipment 100. User equipment 100 may transfer the input event processing results to external device 200, using a reconfigured control path as described in FIG. 8. External device 200 may display the input event processing results using display unit 260.

In at least one embodiment of the present invention, MHL transceiving driver 194 may transfer the received coupling event data to coupling agent 192. In this case, coupling agent 192 may perform the operations of step S1202 to step S1206.

FIG. 12B illustrates processing the coupling event data through input drivers (i.e., input sub-device drivers).

Referring to FIG. 12B, user equipment 100 may receive a coupling event data through MHL control bus (CBUS) from a connected external device 100 at step S1220. More specifically, MHL transceiving driver 194 of user equipment 100 may receive the coupling event data MHL control bus (CBUS) from MHL transceiving driver 294 of external device 200 connected to user equipment 100.

At step S1222, MHL transceiving driver 194 may analyze the received coupling event data. Herein, the received coupling event data may header field 1010 and input event data field 1020. Since a frame structure of the received coupling event data was already described with reference to FIG. 10A to FIG. 10C, the detailed description thereof is omitted.

At step S1224, MHL transceiving driver 194 may identify an input event type from header 1010 of the received coupling event data, based on the analysis results. Herein, the input event type may be one of a key input event (e.g., a keyboard input event), a pointing input event (e.g., a mouse input event, a touch pad input event, etc.), and a touch input event (e.g., a touch screen input event).

At step S1226, MHL transceiving driver 194 may obtain input event data from input event data field 1020 of the received coupling event data, based on the analysis results.

At step S1228, MHL transceiving driver 194 may transfer the input event data to an input sub-device driver corresponding to the identified input event type. Herein, the input sub-device driver may be any one of key input sub-device driver 94 (i.e., a key input driver) such as a keyboard driver, pointing input sub-device driver 95 (i.e., a pointing input driver) such as a mouse driver or a touch pad driver, and touch input sub-device driver 96 (i.e., a touch input driver) such as a touch screen driver. For example, in the case of that the received input event data is a mouse input data, MHL transceiving driver 194 may transfer the mouse input data to pointing input driver 95.

A step S1230, the input event data may be processed by a corresponding input sub-device driver. For example, in the case of that the received input event data is a mouse input data, pointing input driver 95 may process the mouse input data.

When the input event data is processed by a corresponding input sub-device driver, input event processing results may be displayed in user equipment 100. User equipment 100 may transfer the input event processing results to external device 200, using a reconfigured control path as described in FIG. 8. External device 200 may display the input event processing results using display unit 260.

FIG. 12C illustrates processing the coupling event data through one of coupling agent 192 and an input driver according to input event types.

Referring to FIG. 12C, user equipment 100 may receive a coupling event data through MHL control bus (CBUS) from a connected external device 100 at step S1240. More specifically, MHL transceiving driver 194 of user equipment 100 may receive the coupling event data MHL control bus (CBUS) from MHL transceiving driver 294 of external device 200 connected to user equipment 100.

At step S1242, MHL transceiving driver 194 may analyze the received coupling event data. Herein, the received coupling event data may header field 1010 and input event data field 1020. Since a frame structure of the received coupling event data was already described with reference to FIG. 10A to FIG. 10C, the detailed description thereof is omitted.

At step S1244, MHL transceiving driver 194 may identify an input event type from a header of the received coupling event data, based on the analysis results. Herein, the input event type may be one of a key input event (e.g., a keyboard input event), a pointing input event (e.g., a mouse input event, a touch pad input event, etc.), and a touch input event (e.g., a touch screen input event).

At step S1246, MHL transceiving driver 194 may obtain input event data from input event data field of the received coupling event data, based on the analysis results.

When the input event type is “an API related input event” (S1248), MHL transceiving driver 194 may transfer the obtained input event data to coupling agent 192 at step S1250. Herein, the API related input event may indicate an input event whose input API is included in user equipment 100. For example, in the case that user equipment 100 includes a key input API 91 and the input event type is a key input event, MHL transceiving driver 194 may transfer the obtained input event data (i.e., key input event data) and/or the identified input event type to coupling agent 192. Further, in the case that a plurality of input APIs are included in user equipment 100, MHL transceiving driver 194 may further transfer the identified input event type to coupling agent 192.

At step S1252, when receiving the obtained input event data and the identified input event type from MHL transceiving driver 194, coupling agent 192 may transfer the received input event data to input API corresponding to the received input event type. In the above-noted case, coupling agent 192 may transfer the received key input data to key input API 91.

At step S1254, the input event data may be processed through the corresponding input API. That is, when receiving input event data from coupling agent 192, a corresponding input API of input APIs 91 to 93 may process the received input event data. For example, in the above-noted case, key input API 91 may process the key input data.

When the input event type is “a driver related input event” (S1248), MHL transceiving driver 194 may transfer the input event data to an input sub-device driver corresponding to the identified input event type at step S1256. Herein, the driver related input event may indicate an input event whose input driver is included in user equipment 100. For example, in the case that user equipment 100 includes pointing input driver 95 and touch input driver 96, MHL transceiving driver 194 may transfer pointing input event data (e.g., mouse input data) to pointing input sub-device driver 95 (e.g., a mouse driver), and transfer touch input event data (e.g., touch screen input data) to touch input sub-device driver 96 (e.g., a touch screen driver).

At step S1258, the input event data may be processed by a corresponding input sub-device driver. When the input event data is processed by an input sub-device API or an input sub-device driver, input event processing results may be displayed in user equipment 100. User equipment 100 may transfer the input event processing results to external device 200, using a reconfigured control path as described in FIG. 8. External device 200 may display the input event processing results using display unit 260.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of processing an input event of an external device in user equipment, the method comprising:
receiving coupling event data from the external device coupled to the user equipment;
identifying an input event type associated with the received coupling event data;
obtaining input event data from the received coupling event data; and
processing the obtained input event data using at least one of an input application programming interface (API) and an input sub-device driver, according to the identified input event type.

2. The method of claim 1, further comprising:
reconfiguring a device control path in association with the external device.

3. The method of claim 2, wherein the reconfiguring includes:
receiving external sub-device information on at least one external sub-device included in the external device, from the external device;
selecting at least one external sub-device to be controlled by the user equipment, among the at least one external sub-device;
obtaining sub-device information on at least one sub-device of user equipment corresponding to the selected at least one external sub-device;
transmitting the obtained sub-device information to the external device; and
reconfiguring the device control path such that a corresponding external sub-device may be controlled.

4. The method of claim 1, wherein at least one of a structure and a size of the coupling event data is determined based on at least one of a data transmission amount and a data transmission period.

5. The method of claim 4, wherein the data transmission period is determined based on a data interrupt processing speed of the user equipment.

6. The method of claim 1, wherein the coupling event data includes:
a header including a device type and an event state; and
an input event data field, and
wherein the event state includes a device connection state; and a property of input event data included in the input event data field.

7. The method of claim 1, wherein the coupling event data is received from the external device in burst mode through a control bus (CBUS) of a mobile high-definition link (MHL) port.

8. The method of claim 7, wherein the processing includes:
transferring, by an MHL transceiving driver, the obtained input event data and the identified input event type to a coupling agent; and
forwarding, by the coupling agent, the transferred input event data to the corresponding input API according to the identified input event type.

9. The method of claim 7, wherein the processing includes:
transferring, by an MHL transceiving driver, the obtained input event data to the corresponding input sub-device driver according to the identified input event type.

10. The method of claim 7, wherein the processing includes:
transferring, by an MHL transceiving driver, the obtained input event data and the identified input event type to a coupling agent when the identified input event type is an API related input event;
forwarding, by the coupling agent, the transferred input event data to the corresponding input API according to the identified input event type; and
transferring, by the MHL transceiving driver, the obtained input event data to the corresponding input sub-device driver when the identified input event type is a driver related event.

11. A method of processing an input event in an external device coupled to user equipment, the method comprising:
sensing input event data generated from at least one input unit of the external device;
creating coupling event data including the generated input event data and input event type information; and
transmitting the created coupling event data to the user equipment.

12. The method of claim 11, further comprising:
performing an operation setting synchronization in association with the user equipment.

13. The method of claim 12, wherein the performing includes:
transmitting external sub-device information on at least one external sub-device included in the external device, to the user equipment;
receiving operation setting information on at least one sub-device of user equipment corresponding to the at least one external sub-device; and
changing the operation setting of the at least one external sub-device, based on the received operation setting information.

14. The method of claim 11, wherein at least one of a structure and a size of the coupling event data is determined based on at least one of a data transmission amount and a data transmission period.

15. The method of claim 14, wherein the data transmission period is determined based on a data interrupt processing speed of the user equipment.

16. The method of claim 11, wherein the created coupling event data includes:
a header including a device type and an event state; and
an input event data field, and
wherein the event state includes a device connection state; and a property of input event data included in the input vent data field.

17. The method of claim 16, wherein:
the header has a size of about 4 bytes; and
the input event data field has a size of about 12 bytes.

18. The method of claim 11, wherein the generated input event data includes at least one of key input event data, pointing input event data, and touch input event data.

19. The method of claim 11, wherein the created coupling event data is transmitted to the user equipment in burst mode through a control bus (CBUS) of a mobile high-definition link (MHL) port.

20. The method of claim 19, wherein the creating is performed by a coupling manager; and
wherein the transmitting includes storing, by an MHL transceiving driver, the created coupling event data received from the coupling manager; and transmitting the stored coupling event data by the MHL transceiving driver.
